(19) United States
(12) Patent Application Publication
(10) Pub. No.: US 2008/0056407 A1
(43) Pub. Date: Mar. 6, 2008

(54) Method, device, computer program product and apparatus providing a multi-dimensional CPM waveform

(75) Inventors: Marilynn P. Green, Coppell, TX (US); Anthony Reid, Plano, TX (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/897,368

(22) Filed: Aug. 30, 2007

Related U.S. Application Data
(60) Provisional application No. 60/841,894, filed on Aug. 31, 2006.
(60) Provisional application No. 60/841,929, filed on Aug. 31, 2006.
(60) Provisional application No. 60/841,930, filed on Aug. 31, 2006.

(51) Int. Cl. H04L 27/20

(52) U.S. Cl. 375/302

(57) ABSTRACT

A method is described for generating a M-D CPM waveform as a constant envelope, continuous phase signal capable of conveying a plurality of information symbols per symbol interval. Additionally, it provides for reducing the phase state space of the M-D CPM waveform, for reducing a number of trellis states required for demodulation of the M-D CPM waveform, and for implementing generalized tilted phase decomposition to reduce the cardinality of the phase state space of the multi-dimensional CPM waveform by a factor of 2. A device, computer program product and apparatus are also described.

### CROSS REFERENCE TO RELATED APPLICATIONS

This patent application claims priority under 35 U.S.C. §119(e) from U.S. Provisional Application Nos. 60/841,894, 60/841,929, 60/841,930, all filed Aug. 31, 2006, the disclosures of which are incorporated by reference herein in its entirety.

### TECHNICAL FIELD

Exemplary and non-limiting embodiments of this invention relate generally to methods, apparatus and computer program products that modulate information to a carrier, such as a radio frequency carrier, and, more specifically, relate to a class of modulators known as continuous phase modulators.

### BACKGROUND

The following abbreviations are herewith defined:

### BLER block error ratio

### BPF bandpass filer

### BPSK binary phase shift keying

### CE convolutional encoder

### CPE continuous phase encoder

### CPM continuous phase modulation

### DFT discrete Fourier transform

### DL downlink (e.g., from base station to mobile device)

### GMSK Gaussian minimum shift keying

### GSM global system for mobile communication

### LPF lowpass filter

### MM memory-less modulator

### M-QAM M-ary QAM

### OFDM orthogonal frequency division multiplex

### QAM quadrature amplitude modulation

### QPSK quadrature phase shift keying

### TPD tilted phase decomposition

### UL uplink (e.g., from mobile device to base station)

The growing need for high data rate transmissions over fading channels has stimulated interest in signalling methods with high spectral efficiency. While the continuous phase property of CPM makes it possible to define schemes with a narrow main spectral lobe and small spectral side lobes, this signalling format prevents the transmission of complex constellations, such as M-QAM. Hence, although CPM is known to be both power and bandwidth efficient, thus making it ideal for UL transmission, there is still a need to close the gap between the acceptance of CPM and other, more widely utilized modulation methods.

In order to gain a full understanding of exemplary embodiments of this invention, a brief description of conventional CPM is now provided.

Over the nth symbol interval, a binary single-h CPM waveform can be expressed as

$$s ( t , a , h ) = exp \{ j2π h {\sum }_{i = 0}^{n} {a}_{i} q ( t - i T ) \} , n T \leq t < ( n + 1 ) T , \qquad ( 1 )$$

where T denotes the symbol duration, aᵢε{±1} are the binary data bits and h is the modulation index. The phase response function, q(t), is the integral of the frequency function, ƒ/(t), which is zero outside of the time interval (0,LT) and which is scaled such that

$${\int }_{0}^{LT} f ( τ ) d τ = q ( LT ) = \frac{1}{2} . \qquad ( 2 )$$

An M-ary single-h CPM waveform is the logical extension of the binary single-h case in which the information symbols are now multi-level: e.g., aᵢε{±1, ±3, . . . , ±(M−1)}.

Finally, an M-ary multi-h CPM waveform can be written as

$$s ( t , a , h ) = exp \{ j2π {\sum }_{i = 0}^{n} {a}_{i} {h}_{i} q ( t - i T ) \} , n T \leq t < ( n + 1 ) T , \qquad ( 3 )$$

where aᵢε{±1, ±3, . . . , ±(M−1)} and the modulation index, hₙ assumes its value over the set: {h(1) . . . , h(Nₕ)}. In one implementation, for example, the modulation index may cycle over the set of permitted values.

Considering the constraint in (2), it can be shown that any of these variants of CPM can be written as

$$s ( t , a , h ) = exp \{ j ( {θ}_{n} + 2 π {\sum }_{i = 0}^{L - 1} {a}_{n - i} {h}_{n - i} q ( t - i T ) ) \} , t = τ + n T , \\ 0 \leq τ < T . \qquad ( 4 )$$

The cumulative phase term

$${θ}_{n} = ( π {\sum }_{i = 0}^{n - L} {a}_{i} {h}_{i} ) mod 2 π$$

is the contribution of all past symbols for which q(t-nT) has reached its final value of ½. When the modulation index(es) are rational (e.g., when h(i)=2K(i)/P, where K(i) and P are relatively prime integers), then the cumulative phase term belongs to a time-invariant set of cardinality P in which the points are evenly spaced about the unit circle, e.g.:

$${θ}_{n} ∈ \{ \begin{matrix}0 & \frac{2 π}{P} & … & \frac{2 π ( P - 1 )}{P}\end{matrix} \} .$$

### Hence, conventional CPM can be described as a finite state machine, whose signal is completely defined by the state variable

sₙ=└θₙa_{n-(L-1)} . . . aₙ₋₁┘ (5)

and current input aₙ. By definition, the state variables, sₙ, are drawn from a set of cardinality P-M^{L-1}.

In all of these cases, the input symbols are drawn from a real, integer-valued set. Clearly, complex constellations are prohibited, as an input symbol of the form aᵢ+jbᵢ (where j=\sqrt{−1}) would cause a variation in the envelope of the transmitted waveform and thereby destroy its constant envelope property. Moreover, in order to exploit the finite state machine properties of this waveform, the symbols are restricted to the integer set and the modulation indices are restricted to the rationals.

Some conventional efforts to design CPM schemes with higher spectral efficiency that are known to the inventors have all operated under the constraints of classical CPM (rational modulation indices and integer-valued constellations). Following are several examples of these schemes:

T. Svensson and A. Svensson, “On convolutionally encoded partial response CPM,” in Proc. IEEE Vehicular Technology Conference, Amsterdam, The Netherlands, September 1999, vol. 2, pp. 663-667, finds uncoded CPM schemes for different alphabet sizes and phase pulse lengths under constraints on the spectrum mask.

D. Asano, H. Leib and S. Pasupathy, “Phase smoothing functions for full response CPM,” in Proc. IEEE Pacific Rim Conference on Communications, Computers and Signal Processing, June 1989, pp. 316-319, studies the optimization of the phase pulse for minimizing the effective bandwidth and BER for binary full response CPM.

In M. Campanella, U. Lo Faso and G. Mamola, “Optimum bandwidth-distance performance in full response CPM systems,” IEEE Transactions on Communications, vol. 36, no. 10, pp. 1110-1118, October 1988, there is an analytical solution derived for the optimal phase pulse for binary full response CPM with a prescribed minimum Euclidean distance.

D. Asano, H. Leib and S. Pasupathy, “Phase smoothing functions for full response CPM,” in Proc. IEEE Pacific Rim Conference on Communications, Computers and Signal Processing, June 1989, pp. 316-319, studies the optimization of the phase pulse for minimizing the effective bandwidth and BER for binary full response CPM.

In M. Campanella, U. Lo Faso and G. Mamola, “Optimum bandwidth-distance performance in full response CPM systems,” IEEE Transactions on Communications, vol. 36, no. 10, pp. 1110-1118, October 1988, there is an analytical solution derived for the optimal phase pulse for binary full response CPM with a prescribed minimum Euclidean distance.

All of these conventional CPM approaches constrain the symbol constellation and the modulation indices.

Further, conventional CPM has a time-invariant finite-dimensional (cumulative) phase state space. When the modulation index h=2K/P (K and P are co-prime integers), then the cumulative phase can only assume one of P distinct values:

$$\{ 0 , \frac{2 π}{P} , \frac{4 π}{P} , … , \frac{2 π ( P - 1 )}{P} \} .$$

### Hence, the cumulative phase of a conventional CPM signal assumes values that are equally spaced around the unit circle and its state space is fully described by the vector, s=[θₙ,σₙ], which takes on a total of PM^{L-1} time-invariant, distinct values.

For a discussion of a tilted phase representation for conventional CPM see B. Rimoldi, “A decomposition approach to CPM”, IEEE Trans. On Information Theory, vol. 34, no. 2, March 1998, pp. 260-270, and B. Rimoldi, “Coded continuous phase modulation using ring convolutional codes”, IEEE Trans. On Communications, vol. 43, no. 11, November 1995, pp. 2714-2720).

In “A decomposition approach to CPM”, Rimoldi shows how one may decompose a single-h CPM system into a CPE followed by a MM in such a way that the encoder is linear (modulo M) and time-invariant. This alternate signal representation has been embraced as a leading element in many subsequent CPM studies, as it offers two distinct advantages: (1) this representation forces the phase trajectory to become time-invariant (which simplifies the receiver design for optimal detection) and (2) it also offers insight into a simplified transmitter architecture for generating a convolutionally encoded CPM waveform (as disclosed in “Coded continuous phase modulation using ring convolutional codes”). In brief, Rimoldi's tilted phase representation exploits the fact that since the convolutional code and the CPE are over the same algebra (ring of integers modulo M), the state of the CPE can be fed back and used by the convolutional encoder. This concept is shown herein in FIGS. 1A and 1B, which reproduce FIGS. 1 and 4, respectively, from B. Rimoldi, “Coded continuous phase modulation using ring convolutional codes”, IEEE Trans. On Communications, vol. 43, no. 11, November 1995, pp. 2714-2720. FIG. 1 shows a block diagram of an M-ary CPM scheme with modulation index h=K/P. The CPM scheme id decomposed into a CPE followed by a MM. FIG. 2 shows a combination of an external convolutional encoder over the ring of integers modulo M with an M-ary CPM scheme. The input and the output of both the CE and the CPE are M-ary.

### SUMMARY OF THE INVENTION

An exemplary embodiment in accordance with this invention is a method for providing a multi-dimensional continuous phase modulation waveform. A basis vector space v={v₁, . . . v_{\sqrt{M}}}ε [symbol] ^{\sqrt{M}} is selected. Elements of the basis vector space v are multiplied by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions. At least one of the products is irrational. Each of the products is transmitted in an n-th symbol interval over a constant envelope waveform having continuous phase modulation across the \sqrt{M} dimensions.

An additional exemplary embodiment in accordance with this invention is a device for providing a multi-dimensional continuous phase modulation waveform. The device includes a processor configured to select a basis vector space v={v₁, . . . v_{\sqrt{M}}}ε [symbol] ^{\sqrt{M}}, and configured to multiply elements of the basis vector space v by information symbols λ_{i,m} of the set Λᵢ={λ_{i,1}, . . . λ_{i\sqrt{M}}}ε [symbol] ^{\sqrt{M}} to achieve a product for each of \sqrt{M} signal dimensions. At least one of the products is irrational. The device has a transmitter configured to transmit each of the products in an n-th symbol interval over a constant envelope waveform having continuous phase modulation across the \sqrt{M} dimensions.

A further exemplary embodiment in accordance with this invention is a computer readable medium embodied with a computer program for providing a multi-dimensional continuous phase modulation waveform. The program includes selecting a basis vector space v={v₁, . . . v_{\sqrt{M}}}ε [symbol] ^{\sqrt{M}}. The program multiplies elements of the basis vector space v by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions. At least one of the products is irrational. The program includes instructions for transmitting each of the products in an n-th symbol interval over a constant envelope waveform having continuous phase modulation across the \sqrt{M} dimensions.

An additional exemplary embodiment in accordance with this invention is an apparatus for providing a multi-dimensional continuous phase modulation waveform. The apparatus includes means for selecting a basis vector space v={v₁, . . . v_{\sqrt{M}}}ε [symbol] ^{\sqrt{M}}. The apparatus also has means for multiplying elements of the basis vector space v by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions. At least one of the products is irrational. The apparatus has means for transmitting each of the products in an n-th symbol interval over a constant envelope waveform having continuous phase modulation across the \sqrt{M} dimensions.

In a particular exemplary embodiment, the means for selecting and the means for multiplying include a processor; and the means for transmitting includes a transmitter.

### BRIEF DESCRIPTION OF THE DRAWINGS

In the attached Drawing Figures:

FIGS. 1A and 1B show transmitting an M-ary CPM scheme with modulation index h=KIP using a CPE and a MM (FIG. 1A), and the combination of an external convolutional encoder over a ring of integers modulo M with an M-ary CPM scheme (FIG. 1B).

FIG. 2 is a simplified block diagram of an apparatus that includes a modulator that operates in accordance with the multi-dimensional CPM teachings in accordance with exemplary embodiments of this invention.

FIG. 3 is an exemplary circuit diagram, partially in block diagram form, that illustrates a generalized transmitter that includes a multi-dimensional CPM modulator.

FIG. 4 is an exemplary circuit diagram, partially in block diagram form, that illustrates a generalized receiver that includes a multi-dimensional CPM demodulator.

FIG. 5 shows a comparison of the mutual information rate for multi-dimensional CPM versus conventional CPM and BPSK/QPSK/16-QAM.

FIG. 6 shows a comparison of the power spectrum of conventional CPM (h=1) and multi-dimensional CPM (h=1).

FIG. 7 shows a comparison of the power spectrum of conventional CPM (h=¼) and multi-dimensional CPM (h=¼).

FIG. 8 shows a comparison of the power spectrum of conventional CPM (h=½) and multi-dimensional CPM (h=½).

FIG. 9 shows a comparison of the power spectrum of conventional CPM (h=⅓) and multi-dimensional CPM (h=⅓).

FIG. 10 shows a comparison of the spectra of conventional binary CPM and quaternary CPM (M=2 versus M=4) for L=2, raised cosine frequency pulse shaping, h=½.

FIG. 11 is a generalized phase state transition diagram, which indicates the state transitions as a function of time and the maximum number of phase states at each time instant.

FIG. 12 is a graph showing a number of phase states needed to describe multi-dimensional CPM as a function of time and as a function of the modulation index for v=[1 \sqrt{3}].

FIG. 13 illustrates the trajectory of the (continuous) phase state space when h=½.

FIG. 14 depicts the cumulative phase of multi-dimensional CPM over 500 symbol intervals.

FIG. 15 shows the cumulative phase of multi-dimensional CPM over 500 symbol intervals using phase response pulse shaping in accordance with an exemplary embodiment of this invention.

FIG. 16 shows the cumulative phase of multi-dimensional CPM over 500 symbol intervals.

FIG. 17 illustrates the cumulative phase of multi-dimensional CPM over 500 symbol intervals using phase response pulse shaping in accordance with an embodiment of this invention.

FIG. 18 illustrates the cumulative phase of multi-dimensional CPM over 500 symbol intervals.

FIG. 19 shows the cumulative phase of multi-dimensional CPM over 500 symbol intervals.

FIG. 20 presents an example of scaling the phase response function to reach a desired final value, where the resulting function is both smooth and continuous.

FIG. 21 is an exemplary circuit diagram, partially in block diagram form, that illustrates a generalized transmitter that includes a multi-dimensional CPM modulator that uses special data-dependent tail symbols in accordance with an exemplary embodiment of this invention.

FIG. 22 is a block diagram of circuitry to perform a generalized tilted phase decomposition for multi-dimensional CPM for h=K/P.

FIG. 23 is a graph that illustrates a comparison between a total number of cumulative phase states using Tilted Phase Decomposition (TPD) versus a conventional (C) definition of cumulative phase for a multi-dimensional CPM signal.

FIG. 24 is a circuit block diagram that illustrates a combination of an external CE over a ring of integers modulo M with a multi-dimensional CPM scheme, where the input and output of both the CE and the CPE are M-ary (weighted by the appropriate basis for that particular signal dimension).

FIG. 25 illustrates a flow diagram of a method in accordance with an embodiment of this invention.

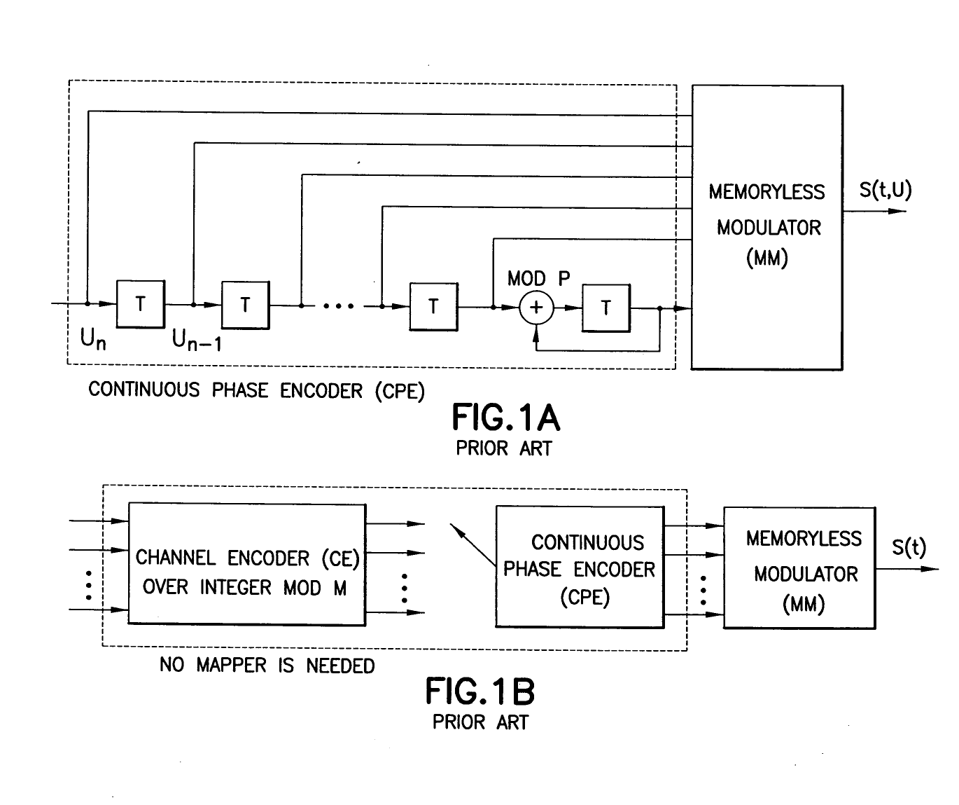

### DETAILED DESCRIPTION

Exemplary embodiments of this invention provide a multi-dimensional CPM apparatus and method.

One of the problems noted above, e.g., that in conventional CPM the symbols are restricted to the integer set and the modulation indices are restricted to the rationals, is overcome in accordance with exemplary embodiments of this invention so as to generalize CPM into a wider signaling class.

As was noted, the conventional approaches to designing CPM to have a higher spectral efficiency constrain the symbol constellation and the modulation indices. However, the use of exemplary embodiments of this invention opens the symbol constellation to a set of much larger cardinality (by also including rationals and irrationals). One may use optimization techniques in order to find a symbol constellation that does as well as, or improves the characteristics of, the novel CPM waveform, as compared to the conventional approaches that are known to the inventors.

Described now is an approach to the design of more spectrally efficient CPM apparatus and waveforms. Exemplary embodiments, which may be generically classified as multi-dimensional CPM, have both the continuous phase and constant envelope property of conventional CPM so as to cause the power spectrum to be well defined. However, one significant aspect of the inventive approach described herein, which serves to clearly differentiate it from the conventional CPM approaches known to the inventors, is that constellations are considered that are constructed in vector spaces, or as lattices associated with algebraic number fields. Hence, the transmitted information symbols, which assume values on the real line, are not necessarily restricted to be integers or rational numbers.

Practically speaking, the vector space construction implies that one defines an N-dimensional vector basis: v=[v₁ . . . v_{N}] (which could be defined from the elements of a basis of an N-dimensional lattice) and then use the defined vector basis to send N information symbols Λᵢ=└λ_{i,1} . . . λ_{i,N}┘ in the phase of the transmitted waveform during each symbol interval (the details of which are described below). Although the information symbols themselves may still be drawn from a conventional integer-valued symbol constellation, the elements of the vector basis drawn from a real lattice may be rational or irrational. Hence, the effectively transmitted information symbols (which are each defined as the product of a vector basis element with an actual information symbol), {vₙλ_{i,n}}ₙ₌₁^{N}, can be rational or irrational.

Conventional CPM is used to send one information symbol per interval, which limits its spectral efficiency vis-à-vis other modulation methods that can send a complex symbol, or that can employ amplitude and phase modulation over the same period of time. While amplitude modulation of the CPM waveform to increase its efficiency is one alternative, this approach is not further considered herein since a desired goal is to retain the constant envelope property of the CPM waveform so that it can be used with cost-efficient non-linear power amplifiers without distorting the information-bearing portion of the waveform. Exemplary embodiments of this invention address this problem by defining a constant envelope, continuous phase signal that is capable of transmitting a multi-dimensional information symbol during each transmission interval. Thus, exemplary embodiments of this invention generalize CPM into a wider signaling class that is capable of sending more than one information symbol per symbol interval in a constant amplitude, continuous phase format.

By removing some of the classical restrictions that have been imposed on CPM, a means is provided by which a more robust CPM signal design is achieved, which has enhanced spectral containment, higher capacity and lower probability of intercept than conventional CPM. Thus, one is enabled to optimize the multi-dimensional CPM based on multiple performance criteria.

Described now is a newly proposed class of constant envelope, continuous phase signals which construct their modulation symbols as higher dimensional modulations in vector space, or as lattices associated with algebraic fields.

Algebraic fields remove some of the restrictions associated with the use of conventional complex constellations, such as M-QAM, which do not explicitly fit the CPM signal model. Real lattice-based constellations have been proposed in other venues as spectrally efficient alternatives for transmission over Rayleigh fading channels. In the ensuing description they are used as a mechanism to design a class of more spectrally efficient alternatives to conventional M-ary CPM.

Conventional CPM uses M-ary symbol constellations, wherein the symbol set is taken from the real integer set {−(M−1), . . . −1, 1, . . . ,(M−1)}. By definition, M=2^{K} and K is an integer. Since the information symbols are encoded into the phase of the transmitted signal, they are restricted to the real line (otherwise the constant envelope property would be lost).

### Multi-Dimensional CPM:

A detailed description of multi-dimensional CPM signaling is now provided. Although the formulation is provided for single-h multi-dimensional CPM, it should be noted that exemplary embodiments of this invention apply to the multi-h counterparts as well.

The complex baseband equivalent of a general multi-dimensional CPM waveform is defined as

s(t,λ)=e^{jφ(t,λ)}, (6)

with λ denoting a multi-dimensional information sequence. Assuming that transmissions start at time t=0, then over the nth symbol interval the information carrying phase can be expressed as

$$φ ( t , λ ) = 2 π h {\sum }_{i = 0}^{n} {\sum }_{m = 1}^{\sqrt{M}} {λ}_{i , m} {v}_{m} {q}_{m} ( t - i T ) , \qquad ( 7 )$$

where v={v₁,v₂, . . . , v_{\sqrt{M}}}ε [symbol] ^{\sqrt{M}} is an information-carrying basis vector and λ_{i,m} are the \sqrt{M}-ary information symbols that are carried on each signal dimension. Hence, λ_{i,m}ε{±1, ±3, . . . , ±(\sqrt{M}−1)}. It should be noted here that a \sqrt{M}-multi-dimensional CPM modulation is used as an alternative to M-ary CPM, as both carry the same number of information symbols during each symbol interval (M=\sqrt{M} symbols/signal dimension×\sqrt{M} signal dimensions).

The phase response functions all satisfy the generalized constraints:

$${q}_{m} ( t ) = \{ \begin{matrix}0 , & t \leq 0 \\ {q}_{m} ( LT ) , & t \geq LT\end{matrix} \\ m = 1 , … , \sqrt{M} . \qquad ( 8 )$$

while a more conventional approach would make the assumption that qᵢₙ(t)=½. L denotes the memory length of the transmitted waveform.

Multi-dimensional CPM is envisioned for alternative use with uplink transmission, where the use of less costly, power-efficient nonlinear power amplification can be used to help increase battery life. This arrangement places the responsibility of demodulation and decoding at the base station and is conducive to a network that might use OFDM for the DL and multi-dimensional CPM for the UL.

Several observations are pertinent. First, unlike conventional CPM which assigns a final value of q(LT)=½, this generalized formulation makes no such restriction on the phase response. As is demonstrated below, this feature provides greater flexibility in controlling the state space of the multi-dimensional CPM waveform.

Secondly, the only restriction that is made on the basis vector, v, is that it consist of real elements. Hence, this model is categorically inclusive of rational and irrational numbers in the phase argument. Hence, the effective information symbol that is being sent on each dimension is λ_{i,m}vₘ, which can be irrational.

The constraints in (8) lead to an equivalent representation of the phase function in (8) in terms of a partial response component and a generalized cumulative phase term, θₙ, which are respectively given by:

$$φ ( t , λ ) = {θ}_{n} + 2 π h {\sum }_{i = 0}^{L - 1} {\sum }_{m = 1}^{\sqrt{M}} {λ}_{i , m} {v}_{m} {q}_{m} ( τ + i T ) \\ {θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} . \qquad ( 9 )$$

Over the nth symbol interval, multi-dimensional CPM is completely described by the set of phase response functions, {q₁(t), . . . , q\sqrt{M}^{(t)}}, the \sqrt{M} current input symbols,

Λₙ=└λ_{n,1} . . . λ_{n,\sqrt{M}}┘, (10)

a correlative state vector that describes the \sqrt{M}(L−1) past information symbols on each signal dimension

σₙ=└λ_{n-(L-1),1} . . . λ_{n-(L-1),1\sqrt{M}} . . . λ_{n-1,1} . . . λ_{n-1,\sqrt{M}}┘, (11)

and the cumulative phase term, θₙ, which accumulates the contributions from past symbols, as defined in (9).

As an example, consider a 2-ary multi-dimensional CPM construction (M=4) in which v=[1 \sqrt{3}] and the information symbols λᵢε{−1,+1} are binary. In this case, the effective information symbol set is given by {−1,+1,−\sqrt{3},+\sqrt{3}}, which includes two irrational elements.

The cumulative phase term for multi-dimensional CPM is defined as

$${θ}_{n} = ( 2 π h {\sum }_{i = 0}^{n - L} {\sum }_{m = 1}^{\sqrt{M}} {λ}_{i , m} {v}_{m} {q}_{m} ( LT ) ) mod 2 π . \qquad ( 12 )$$

The properties of the cumulative phase term are dependent on the selected vector basis, v, and on the final value of the phase response function for each signal dimension, qₘ(LT).

In the previous example, when v=[1 \sqrt{3}], λᵢε{−1,+1} and q₁(LT)=q₂ (LT)=½, then

$${θ}_{n} = ( π h {\sum }_{i = 0}^{n - L} ( {λ}_{i , 1} \cdot 1 + {λ}_{i , 2} \cdot \sqrt{3} ) ) mod 2 π . \qquad ( 13 )$$

As a second example, consider now a case where v=[1 \sqrt{3}], λᵢε{−1,+1},and qₘ(LT)=0. Then, θₙ=0 and the state space has only one member. Thus, the cumulative phase term is a parameter whose characteristics can be shaped by the flexibility of the novel signal model disclosed herein.

These examples have been provided to illustrate the diversity of signal characterizations that can result from generating a multi-dimensional CPM waveform. This diversity can be exploited to design the state space to have the desired properties.

Comparisons are now provided between multi-dimensional CPM in accordance with exemplary embodiments of this invention and other, more conventional signaling formats in two key areas: mutual information rate and spectral occupancy.

The mutual information rate (measured in bits per channel use) is the theoretical channel capacity under the constraint of using a particular modulation scheme, such as 16-QAM or BPSK. Mutual information rate is upper-bounded by Shannon capacity, which quantifies the maximum possible channel capacity over all modulation formats (e.g. unconstrained capacity).

In order to numerically investigate the advantages of multi-dimensional CPM, Monte Carlo simulations have been run in order to calculate its theoretical mutual information rate in a discrete, memory-less channel. In addition, the mutual information rate for BPSK, QPSK, (rectangular) 16-QAM and conventional CPM have been calculated as a function of signal-to-noise ratio (E_{S}/N₀) using Monte Carlo simulation techniques.

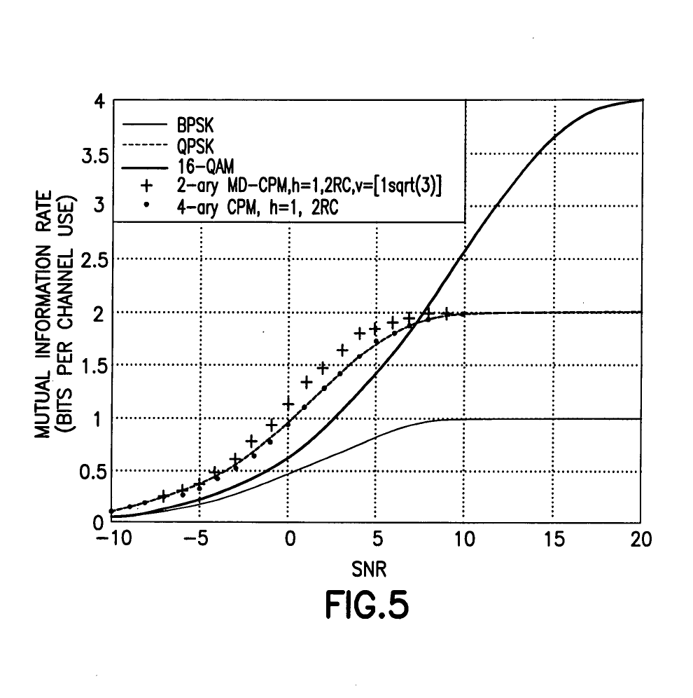

FIG. 5 contains a direct comparison of the mutual information rate for multi-dimensional CPM when h=1, L=2, v=[1 \sqrt{3}] and \sqrt{M}=2 raised cosine frequency pulse shaping to conventional CPM when h=1, L=2, M=4 and raised cosine frequency pulse shaping is used. Also shown are the mutual information rate of BPSK, QPSK and rectangular 16-QAM as a function of the signal-to-noise ratio. As is clearly evidenced in this figure, over signal-to-noise ratios in the range of −10 to 10 dB, the multi-dimensional CPM waveform has a highest mutual information rate of all of the signals which are shown, which means that this modulation format has the highest constrained capacity amongst all the other modulation formats to which it is being compared.

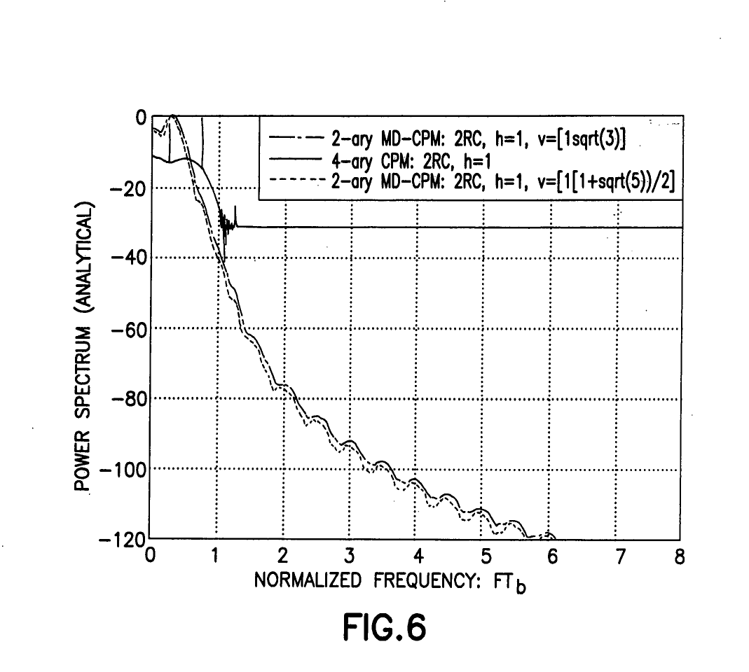

The spectral occupancy has been investigated through analytical calculations of the autocorrelation of multi-dimensional CPM and conventional CPM. Once calculated, the autocorrelation is transformed into the frequency domain, via a discrete Fourier transform operation, and used to numerically evaluate the theoretical spectrum. In FIG. 6 there is shown a comparison of the spectra of multi-dimensional CPM for (1) h=1, L=2, v=[1 \sqrt{3}]; (2) h=1, L=2, v=[1+\sqrt{5})/2] and \sqrt{M}=2 with raised cosine frequency pulse shaping; and (3) conventional CPM in which h=1, L=2, M=4 and raised cosine frequency pulse shaping is used. FIG. 6 clearly shows that the multi-dimensional CPM waveforms have better spectral occupancy than conventional CPM. In addition, the spectral lines which appear in the conventional CPM spectrum are not present for multi-dimensional CPM, which implies that, at least for the case shown, multi-dimensional CPM exhibits a superior spectral efficiency.

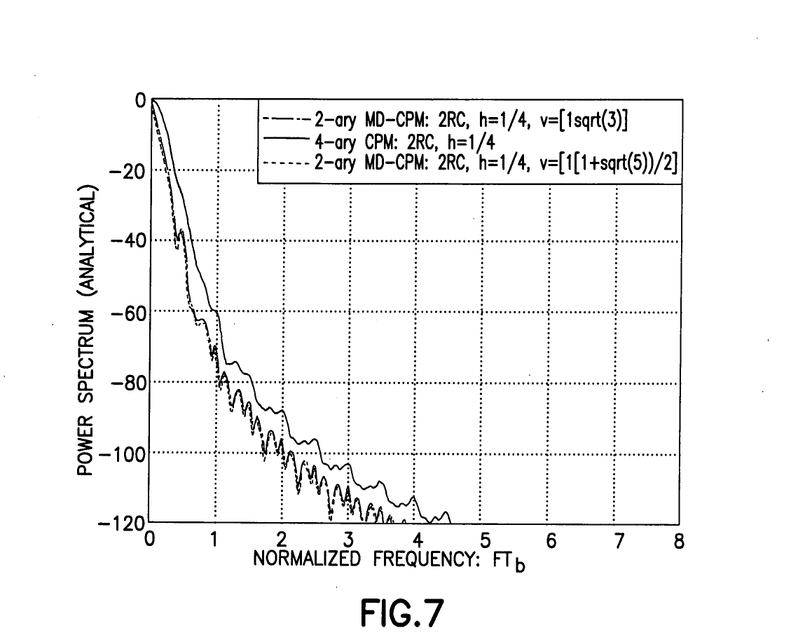

Spectral occupancy comparisons are also shown in FIGS. 7 through 9 for various multi-dimensional CPM and conventional CPM signaling formats. The spectra in these plots all indicate that multi-dimensional CPM has a more compact spectral occupancy than conventional CPM, which makes conformance to a spectral mask an easier task for multi-dimensional CPM.

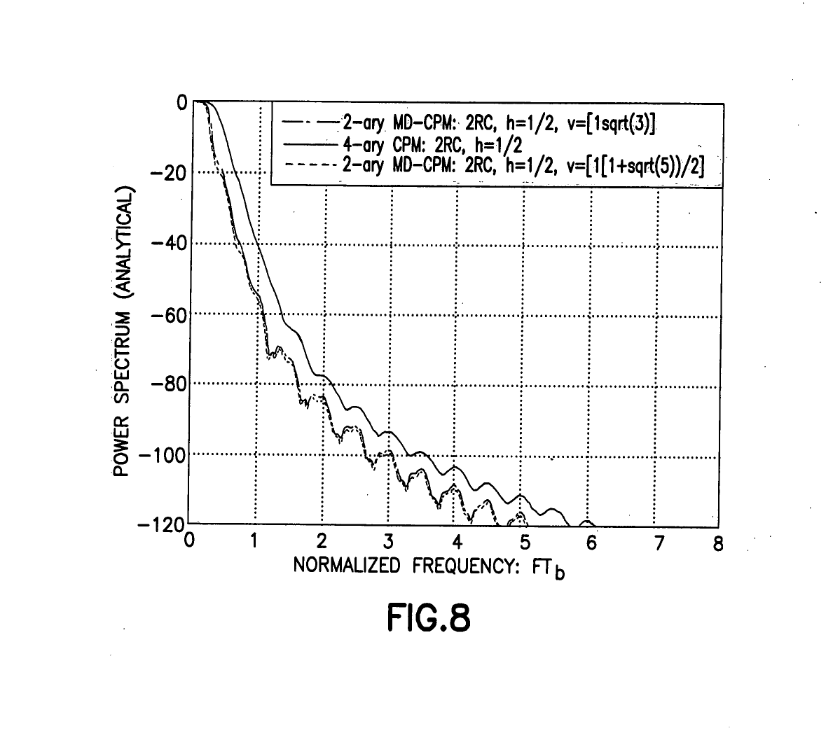

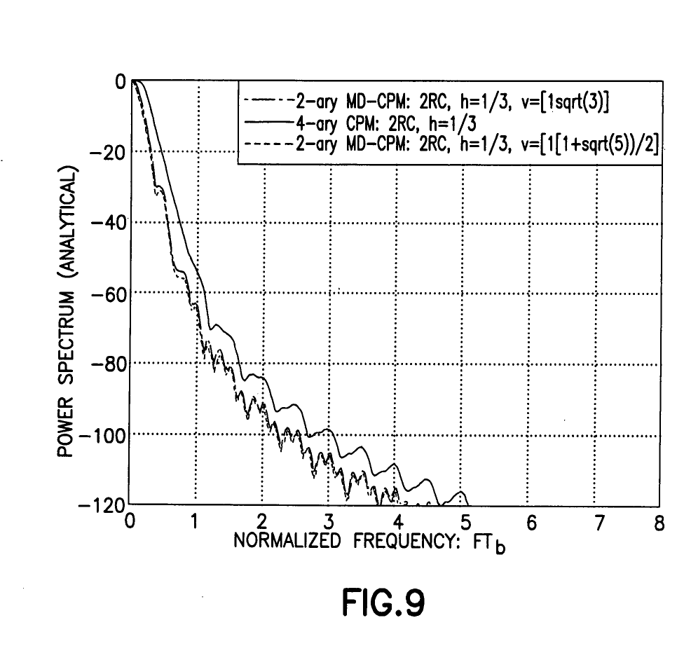

FIG. 7 shows a comparison of the power spectrum of conventional CPM (M=4, L=2, raised cosine frequency pulse shaping, h=¼) and multi-dimensional CPM (M=4, L=2, h=¼, raised cosine, v=[1 \sqrt{3}] and v=[1+\sqrt{5})/2]). FIG. 8 shows a comparison of the power spectrum of conventional CPM (M=4, L=2, raised cosine frequency pulse shaping, h=½) and multi-dimensional CPM (M=4, L=2, h=½, raised cosine, v=[1 \sqrt{3}] and v=[1(1+\sqrt{5})/2]). FIG. 9 shows a comparison of the power spectrum of conventional CPM (M=4, L=2, raised cosine frequency pulse shaping, h=⅓) and multi-dimensional CPM (M=4, L=2, h=⅓, raised cosine, v=[1 \sqrt{3}] and v=[1(1+\sqrt{5})/2]).

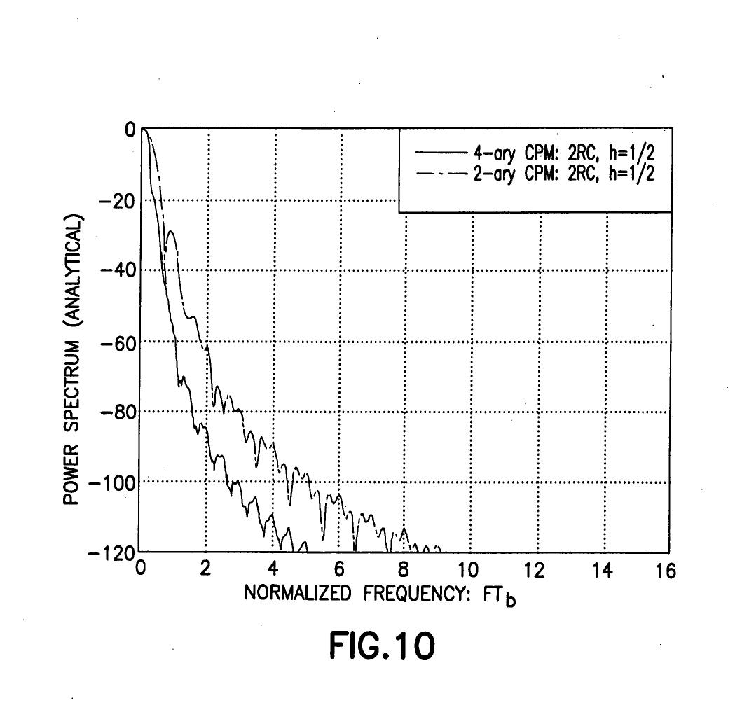

FIG. 10 shows the spectrum of binary CPM versus quaternary CPM for h=½ and L=2 (raised cosine frequency pulse shaping). FIG. 10 underscores the fact that by increasing the modulation order (e.g., by increasing the number of levels in the modulation), one can improve the spectral properties of the CPM signal. Hence, if 2-ary multi-dimensional CPM has a narrower spectrum than 4-ary (quaternary) conventional CPM, then it also has a narrower spectrum than conventional binary CPM. One important waveform that is included in the class of binary CPM waveforms is GMSK, which is used in the GSM standard. Hence, a properly designed multi-dimensional CPM waveform results in a signal that has a narrower main lobe and lower side-lobes than a comparable binary or quaternary CPM waveform.

Based on the foregoing description it should be appreciated that the use of the multi-dimensional CPM waveform in accordance with exemplary embodiments of this invention offers improvement in at least three major areas of communication signal classification.

Spectral containment: the vector basis and phase response functions may be selected to maximize the spectral properties of the transmitted waveforms. This may translate into a narrower main lobe, lower sidelobes, or the absence of spectral lines vis-à-vis conventional CPM.

Spectral efficiency: the vector basis and phase response functions may be selected to maximize number of bits per channel use (e.g. the constrained capacity).

Lower probability of intercept: the increased complexity of the signal reduces the probability that an eavesdropper can decode or interrupt signal transmissions.

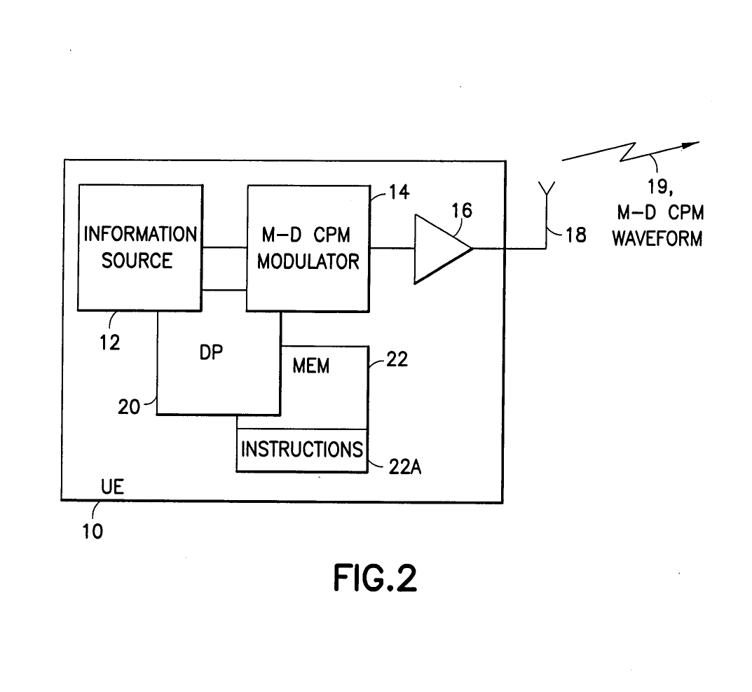

Referring to FIG. 2, there is shown a simplified block diagram of an apparatus, such as a user device or user equipment (UE) 10 that includes an information source 12 coupled to a M-dimensional CPM modulator 14 that operates in accordance with exemplary embodiments of this invention. An output of the M-D CPM modulator 14 is coupled to an amplifier, such as an efficient non-linear amplifier 16 that in turn has an output coupled to an antenna 18. The antenna 18 transmits to a channel the resultant M-D CPM waveform 19 as a constant envelope, continuous phase signal capable of conveying a multi-dimensional information symbol during each transmission interval. That is, the resultant M-D CPM waveform 19 is one that is capable of sending more than one information symbol per symbol interval in a constant amplitude, continuous phase format. The M-D CPM modulator 14 generates modulation symbols as higher dimensional modulations in vector space, or as lattices associated with algebraic fields.

The transmitted M-D CPM waveform 19 may be received by a base station (not shown) where it is demodulated to retrieve the information output from the information source 12. The information may be represented as data encoding an acoustic signal such as voice, or it may be data, such as user data and/or signaling data.

In an embodiment in accordance with this invention the M-D CPM waveform 19 is one wherein the phase state space is reduced in accordance with the use of, as two non-limiting examples, a) special data-dependent tail symbols to force the phase state to return to a predetermined, e.g., zero (cumulative) phase state at pre-specified intervals, or b) pulse shaping of the phase response functions to force the phase state to be time-invariant.

In exemplary embodiments the M-D CPM modulator 14 may be embodied in a network node or component, such as a base station.

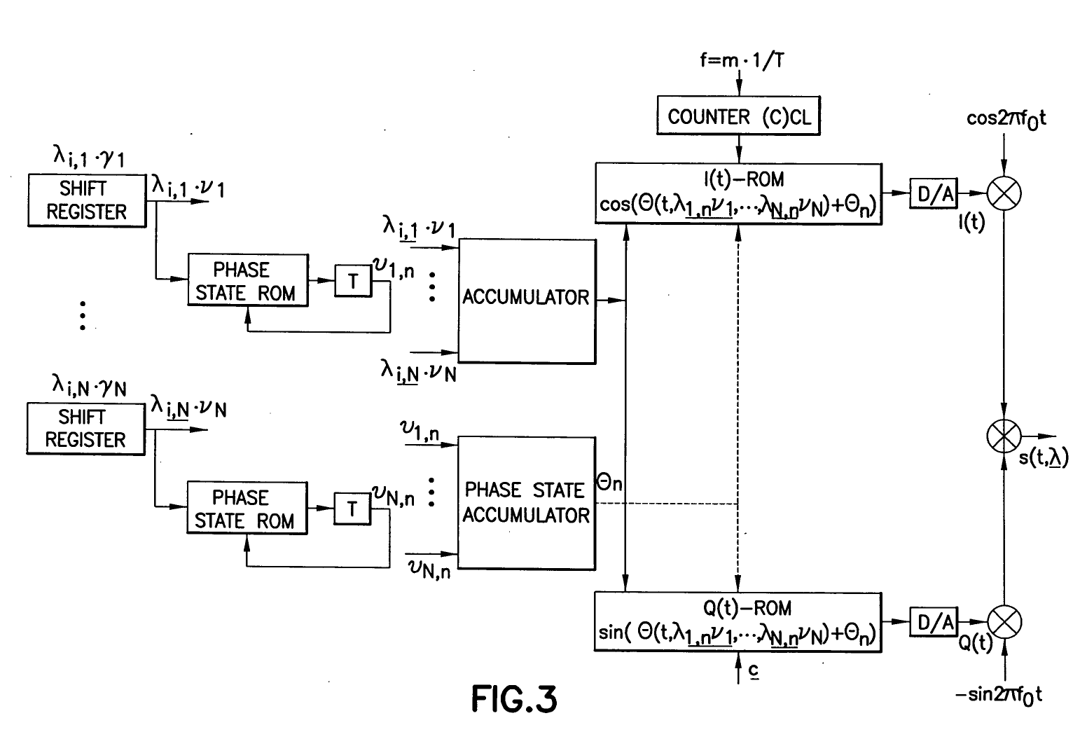

FIG. 3 is an exemplary circuit diagram, partially in block diagram form, that illustrates in greater detail a generalized transmitter that includes the multi-dimensional CPM modulator 14 of FIG. 2.

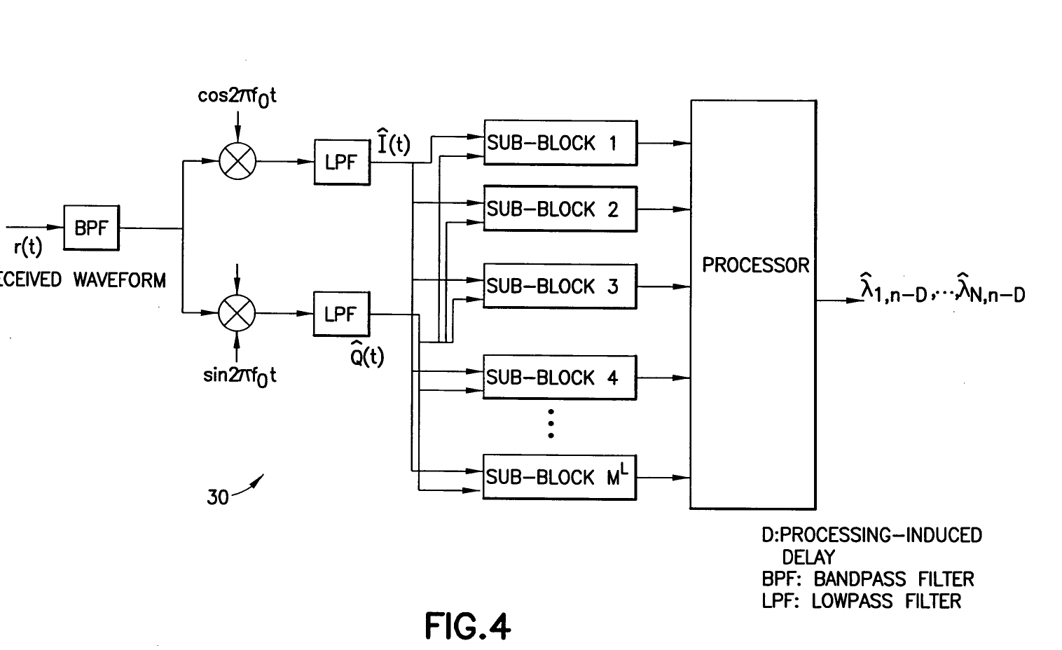

FIG. 4 is an exemplary circuit diagram, partially in block diagram form, that illustrates a generalized receiver that includes a multi-dimensional CPM demodulator 30 for receiving the M-D CPM waveform 19 from the CPM modulator 14, further in accordance with exemplary embodiments of this invention.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Exemplary embodiments of this invention may be implemented in whole or in part by computer software executable by a data processor (DP) 20 of the UE 10, or by hardware, or by a combination of software and hardware. When implemented at least partially in software it can be appreciated that coupled to the DP 20 will be a memory (MEM) 22 that stores a computer program product containing program instructions 22A. The execution of the program instructions 22A result in operations that implement at least one method in accordance with exemplary embodiments of this invention.

An exemplary embodiment in accordance with this invention is a method which comprises considering a complex baseband equivalent of a multi-dimensional CPM waveform such as one defined as s(t,λ)=e^{jφ(t,λ)}, where k denotes a multi-dimensional information sequence, and assuming that transmissions begin at time t=0, then over an nth symbol interval an information carrying phase can be expressed as

$$φ ( t , λ ) = 2 π {\sum }_{i = 0}^{n} {\sum }_{m = 1}^{\sqrt{M}} {h}_{i} {λ}_{i , m} {v}_{m} {q}_{m} ( t - i T ) ,$$

where v={v₁,v₂, . . . , v_{\sqrt{M}}}ε [symbol] ^{\sqrt{M}} is an information-carrying basis vector and λ_{i,m} are the \sqrt{M} ary information symbols that are carried on each signal dimension, where λ_{i,m}ε{±1,±3, . . . , ±(\sqrt{M}−1)}, and where hᵢ denotes the modulation index, which may be a single or a multi-level modulation index.

The method as in the preceding paragraph, where \sqrt{M} multi-dimensional CPM modulation is an alternative to M-ary CPM.

In a method as in the preceding paragraphs where the phase response functions satisfy the generalized constraints:

$${q}_{m} ( t ) = \{ \begin{matrix}0 , & t \leq 0 \\ {q}_{m} ( LT ) , & t \geq LT\end{matrix} \\ m = 1 , … , \sqrt{M} .$$

where these constraints yield an equivalent representation of the phase function in terms of a partial response component and a generalized cumulative phase term, θₙ, which are respectively given by

$$φ ( t , λ ) = {θ}_{n} + 2 π {\sum }_{i = 0}^{n} {\sum }_{m = 1}^{\sqrt{M}} {h}_{i} {λ}_{i , m} {v}_{m} {q}_{m} ( τ + i T )$$

$${θ}_{n} = {( 2 π {\sum }_{i = 0}^{n - L} {\sum }_{m = 1}^{\sqrt{M}} {h}_{i} {λ}_{i , m} {q}_{m} ( LT ) {v}_{m} )}_{mod 2 π} .$$

In a method as in the preceding paragraphs, and over an nth symbol interval, multi-dimensional CPM is completely described by the set of phase response functions, {q₁(t), . . . , q\sqrt{M}^{(t)}}, the \sqrt{M} current input symbols, Λₙ=└λ_{n,1} . . . λ_{n,\sqrt{M}}┘, a correlative state vector that describes the \sqrt{M}(L−1) past information symbols on each signal dimension σₙ=└λ_{n-(L-1),1} . . . λ_{n-(L-1)1,\sqrt{M}} . . . λ_{n-1,1} . . . λ_{n-1,\sqrt{M}}┘, and the cumulative phase term, θₙ.

A computer program product in accordance with exemplary embodiments of this invention comprises computer-executable instructions stored in a computer-readable medium, the execution of which result in operations that comprise considering a complex baseband equivalent of a multi-dimensional CPM waveform defined as s(t,λ)=e^{jφ(t,λ)}, where λ denotes a multi-dimensional information sequence, and assuming that transmissions begin at time t=0, then over an nth symbol interval an information carrying phase can be expressed as

$$φ ( t , λ ) = 2 π {\sum }_{i = 0}^{n} {\sum }_{m = 1}^{\sqrt{M}} {h}_{i} {λ}_{i , m} {v}_{m} {q}_{m} ( t - i T ) ,$$

where v={v₁,v₂, . . . , v_{\sqrt{M}}}ε [symbol] ^{\sqrt{M}} is an information-carrying basis vector and λ_{i,m} are the \sqrt{M}-ary information symbols that are carried on each signal dimension, where λ_{i,m}ε{±1,±3, . . . ±(\sqrt{M}−1)}, and where hᵢ denotes the modulation index, which may be a single or a multi-level modulation index.

The computer program product as in the preceding paragraph, where \sqrt{M}-multi-dimensional CPM modulation is an alternative to M-ary CPM.

In the computer program product as in the preceding paragraphs the phase response functions all satisfy the generalized constraints:

$${q}_{m} ( t ) = \{ \begin{matrix}0 , & t \leq 0 \\ {q}_{m} ( LT ) , & t \geq LT\end{matrix} \\ m = 1 , … , \sqrt{M} .$$

where these constraints yield an equivalent representation of the phase function in terms of a partial response component and a generalized cumulative phase term, θₙ, which are respectively given by

$$φ ( t , λ ) = {θ}_{n} + 2 π {\sum }_{i = 0}^{n} {\sum }_{m = 1}^{\sqrt{M}} {h}_{i} {λ}_{i , m} {v}_{m} {q}_{m} ( τ + i T )$$

$${θ}_{n} = {( 2 π {\sum }_{i = 0}^{n - L} {\sum }_{m = 1}^{\sqrt{M}} {h}_{i} {λ}_{i , m} {q}_{m} ( LT ) {v}_{m} )}_{mod 2 π} .$$

In the computer program product as in the preceding paragraphs, and over an nth symbol interval, multi-dimensional CPM is completely described by the set of phase response functions, {q₁(t), . . . , q\sqrt{M}^{(t)}}, the \sqrt{M} current input symbols, Λₙ=└λ_{n,1} . . . λ_{n,\sqrt{M}}┘, a correlative state vector that describes the \sqrt{M}(L−1) past information symbols on each signal dimension σₙ=└λ_{n-(L-1),1} . . . λ_{n-(L-1)1,\sqrt{M}} . . . λ_{n-1,1} . . . λ_{n-1,\sqrt{M}}┘, and the cumulative phase term, θₙ.

A multi-dimensional CPM modulator in accordance with an exemplary embodiment of this invention comprises circuitry to generate a multi-dimensional CPM waveform defined as s(t,λ)=e^{jφ(t,λ)}, where λ denotes a multi-dimensional information sequence, and assuming that transmissions begin at time t=0, then over an nth symbol interval an information carrying phase can be expressed as

$$φ ( t , λ ) = 2 π {\sum }_{i = 0}^{n} {\sum }_{m = 1}^{\sqrt{M}} {h}_{i} {λ}_{i , m} {v}_{m} {q}_{m} ( t - i T ) ,$$

where v={v₁, v₂, . . . , v_{\sqrt{M}}ε} [symbol] ^{\sqrt{M}} is an information-carrying basis vector and λ_{i,m} are the \sqrt{M}-ary information symbols that are carried on each signal dimension, where λ_{i,m}ε{±1,±3, . . . , ±(\sqrt{M}−1)}, and where hᵢ denotes the modulation index, which may be a single or a multi-level modulation index.

The multi-dimensional CPM modulator as in the preceding paragraph, where \sqrt{M}-multi-dimensional CPM modulation is an alternative to M-ary CPM.

In the multi-dimensional CPM modulator as in the preceding paragraphs the phase response functions all satisfy the generalized constraints:

$${q}_{m} ( t ) = \{ \begin{matrix}0 , & t \leq 0 \\ {q}_{m} ( LT ) , & t \geq LT\end{matrix} \\ m = 1 , … , \sqrt{M} .$$

where these constraints yield an equivalent representation of the phase function in terms of a partial response component and a generalized cumulative phase term, θₙ, which are respectively given by

$$φ ( t , λ ) = {θ}_{n} + 2 π {\sum }_{i = 0}^{n} {\sum }_{m = 1}^{\sqrt{M}} {h}_{i} {λ}_{i , m} {v}_{m} {q}_{m} ( τ + i T )$$

$${θ}_{n} = {( 2 π {\sum }_{i = 0}^{n - L} {\sum }_{m = 1}^{\sqrt{M}} {h}_{i} {λ}_{i , m} {q}_{m} ( LT ) {v}_{m} )}_{mod 2 π} .$$

In the a multi-dimensional CPM modulator as in the preceding paragraphs, and over an nth symbol interval, multi-dimensional CPM is completely described by the set of phase response functions, {q₁(t), . . . , q\sqrt{M}^{(t)}}, the \sqrt{M} current input symbols, Λₙ=└λ_{n,1} . . . λ_{n,\sqrt{M}}┘, a correlative state vector that describes the \sqrt{M}(L−1) past information symbols on each signal dimension σₙ=└λ_{n-(L-1),1} . . . λ_{n-(L-1)1,\sqrt{M}} . . . λ_{n-1,1} . . . λ_{n-1,\sqrt{M}}┘, and the cumulative phrase term, θₙ.

The multi-dimensional CPM modulator as above, embodied in a mobile communication device.

The multi-dimensional CPM modulator as above, embodied as a part of a transmitter in a mobile communication device.

The multi-dimensional CPM modulator as above, embodied at least in part in an integrated circuit.

In some exemplary embodiments the M-D CPM modulator may be embodied in a network node or component, such as a base station.

Having thus provided an overview of the multi-dimensional CPM a description is now made of techniques to reduce the phase state space of multi-dimensional CPM in accordance with exemplary embodiments of this invention.

It is first noted that the state space description for multi-dimensional CPM is fully captured in the vector

sₙ=[θₙ,σₙ]. (14)

The set of all possible values that the correlative state vector can assume is time-invariant since the modulation alphabet is always the same. However, the set from which the cumulative phase term takes its values is generally time-varying. This property of the cumulative phase state differentiates multi-dimensional CPM from conventional CPM, and is employed as discussed in greater detail below.

The cumulative phase term of multi-dimensional CPM can be shown to generally belong to a set whose cardinality increases with time. This implies that the state space, s=[θₙ,σₙ], is a vector which can take on ΘₙM^{L-1} different values over the nth symbol interval, where Θₙ denotes the number of possible values that the cumulative phase can assume over the interval nT≦t<(n+T)T. For conventional CPM, Θₙ=P.

As will be described, exemplary embodiments of this invention provide novel encoding techniques to reduce the size of the phase state space of multi-dimensional CPM so that the resulting waveform has a complexity that is commensurate with conventional CPM.

Numerical studies of multi-dimensional CPM have revealed that after an initial transient period, the number of possible multi-dimensional CPM phase states at time t (where nT≦t≦(n+1)T) is well approximated by

Θₙ≈2nP. (15)

As an example, one may examine the general properties of the phase state space for M=4, λ_{n,i}=±1. Without a loss of generality, assume that v₁=1 and the basis vector v=[1, v₂]. One may also make the (conventional) assumption that q₁(t)=q₂ (t)=½. Hence, the cumulative phase of the multi-dimensional CPM waveform can be written as

$${θ}_{n} = {( π h {\sum }_{i = 0}^{n - L} ( {λ}_{i , 1} + {λ}_{i , 2} {v}_{2} ) )}_{mod 2 π} .$$

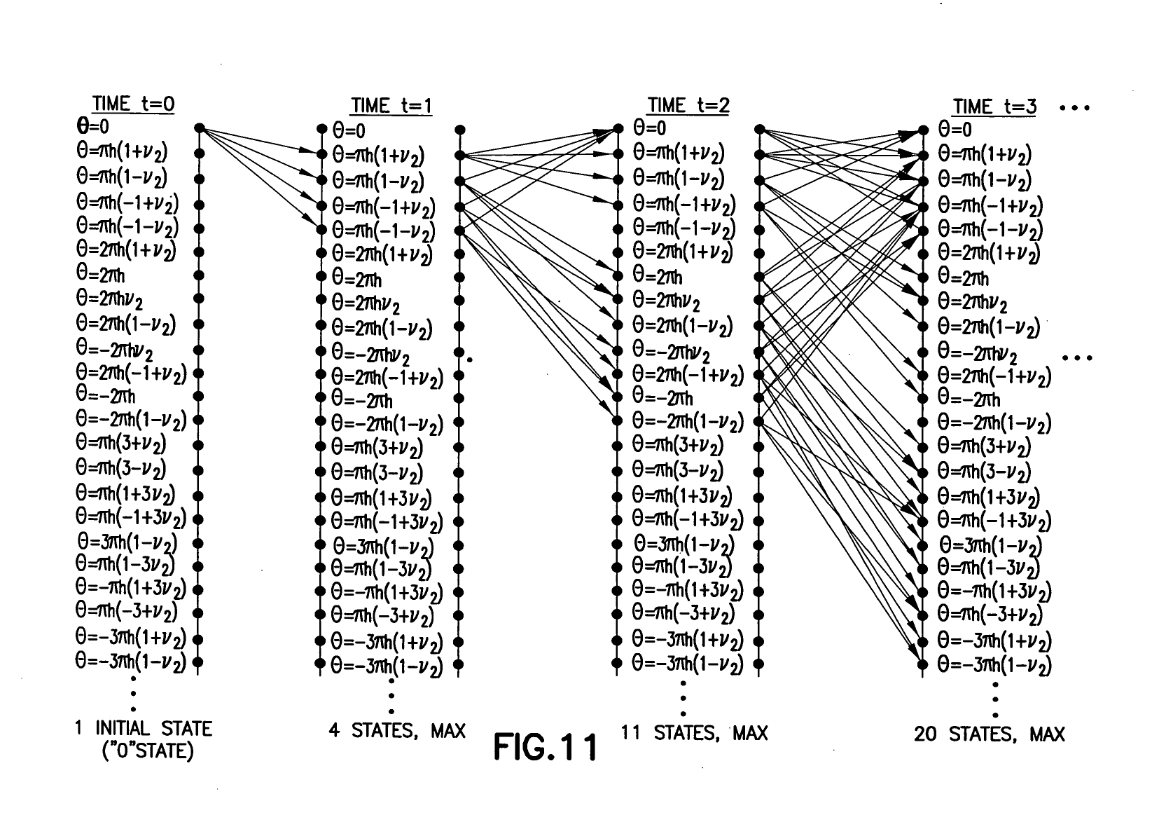

Assuming that the phase state starts in the zero state: θ₀=0, at the time of transition to the next state (n=1), there are four possible values for the phase state, which correspond to the four possible inputs to the cumulative phase: [1+v₂ 1−v₂ −1+v₂ −1−v₂]. These four states can then transition to a maximum of eleven states at n=2. Finally, those eleven states can transition to a maximum possible of twenty states at n=3. The state transitions are illustrated in FIG. 11. Note that FIG. 11 for simplicity only shows the possible states from time n=0 to n=3.

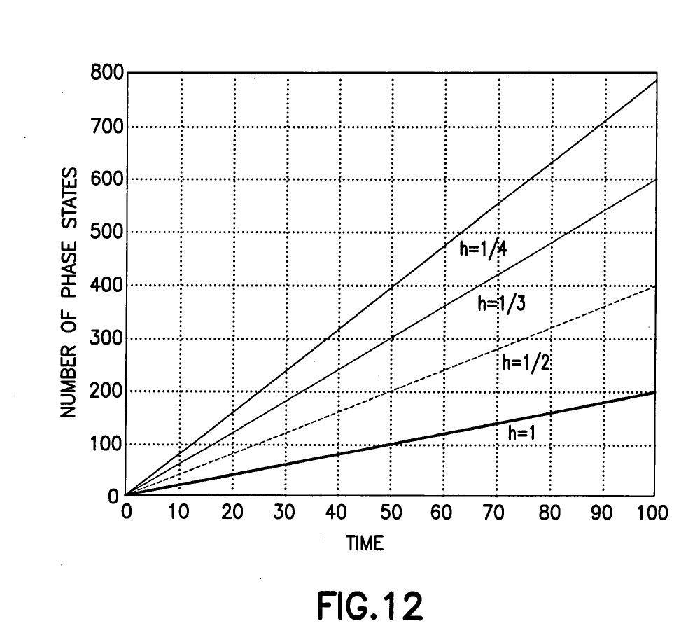

Note should be made of several points that are pertinent to this description. First, due to the symmetry of the input symbols and the fact that v₁=1, there is a linear (and not exponential) increase in the number of states as time evolves, as indicated in (15). This point is further emphasized in FIG. 12, which shows the rate of growth of the cardinality of the cumulative phase state space for the following cases: v=[1,v₂] λ_{n,i}=±1 and h=1, ½, ⅓ and ¼.

The second point to note is that the number of phase states shown in FIG. 11 at each time represents the maximum number of possible phase states, since it is possible (depending on the value of the modulation index) that some of the phase states, when taken modulo 2π, may be equivalent. For example, at time n=2, there is listed θ={0,2πh,−2πh} as being three possible phase states. However, if h=1, then they actually represent the same point on the unit circle. Hence, the number of phase states shown are actually an upper-bound on the number of possible phase states.

In order to reduce the receiver complexity, exemplary embodiments of this invention provide a mechanism to force the phase state of multi-dimensional CPM to have a cardinality that is commensurate with conventional CPM. For example, this may be achieved through the use of exemplary embodiments of this invention, as described below.

A first embodiment employs the use of special data-dependent tail symbols to force the phase state to return to the zero (cumulative) phase state at pre-specified intervals. The use of this embodiment enables one to limit the number of possible cumulative phase states over a specific time window.

A further embodiment employs the use of pulse shaping of the phase response functions to force the phase state to be time-invariant.

Both of these embodiments are low complexity techniques that may be used at the transmitter in order to control the complexity of the multi-dimensional CPM waveform at the receiver.

Further described now are exemplary embodiments of data-dependent encoding schemes that may be utilized to limit the size of the multidimensional-CPM state space over a finite block of transmission symbols. In the following scenarios it is assumed that each multi-dimensional CPM transmission block is used to transmit a total of N information symbols, which are block-demodulated at the receiver.

### Data-Dependent Tail Symbols:

Let λ_{N} be the transmitted multi-dimensional information sequence over a block of N symbol lengths. In this case the transmitter may use a data-dependent tail symbol in order to force the cumulative phase to return to the zero state (or to some other prescribed state) at the end of each transmission block.

Assuming that transmission begins at time t=0, the cumulative phase at the beginning of the nth symbol interval is defined as

$${θ}_{n} = [ π h {\sum }_{m = 1}^{\sqrt{M}} {\sum }_{i = 0}^{n - L} {λ}_{i , m} {v}_{m} ] mod 2 π . \qquad ( 16 )$$

If one defines the (N−L)th input symbol in the transmission block as the cumulative sum of the N−L previous information symbols:

$${λ}_{N - L , m} = - {\sum }_{i = 0}^{N - L - 1} {λ}_{i , m} , \qquad ( 17 )$$

then the cumulative phase term at the beginning of the Nth symbol interval (which coincides with the start of the next transmission block) is given by

$$\begin{matrix}{θ}_{N} = [ π h {\sum }_{m = 1}^{\sqrt{M}} {\sum }_{i = 0}^{N - L} {λ}_{i , m} {v}_{m} ] mod 2π \\ = [ π h {\sum }_{m = 1}^{\sqrt{M}} {\sum }_{i = 0}^{N - L - 1} {λ}_{i , m} {v}_{m} + π h {\sum }_{m = 1}^{\sqrt{M}} {λ}_{N - L , m} {v}_{m} ] mod 2π \\ = 0.\end{matrix} \qquad ( 18 )$$

As may be appreciated, the special tail symbol may have to belong to an extension field of the modulation alphabet.

In general, there is an 1/N information loss over each symbol interval using such an embodiment. However, for the special case where v₁=1, then one only need use the special tail symbol in order to flush the \sqrt{M}−1 other signal dimensions, since the first dimension behaves like a conventional CPM waveform whose cumulative phase state is time-invariant. For the latter case, one may use a special tail symbol to flush the \sqrt{M}−1 other signal dimensions. This implies that the information rate of the N-symbol block (which carries N\sqrt{M} symbols) would be equal to 1-1/N+1/(N\sqrt{M}).

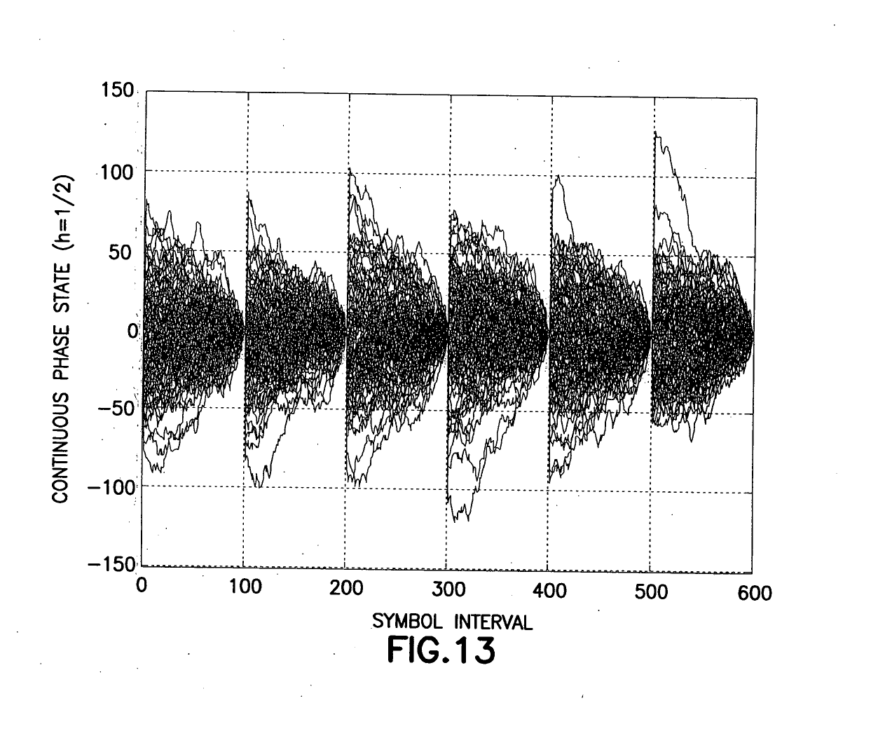

As a simple example, consider a case in which the phase state is required to return to the zero cumulative phase state after every 100 symbols are transmitted. By using the special tail symbol one may obtain a cumulative phase state trajectory as shown in FIG. 13. Note that in FIG. 13 the continuous cumulative phase is shown except at n=100, 200, 300, 400, 500, where its modulo 2π equivalent is shown instead (in order to emphasize the fact that the cumulative phase state is returning to zero at pre-defined intervals). This example clearly shows that by simply introducing a special data-dependent symbol within each data block one may limit the maximum number of possible cumulative phase states to a desirable number.

### Phase Response Function Shaping:

In accordance with an exemplary embodiment that was briefly discussed above, the cumulative phase term can be forced to behave exactly as it does in conventional CPM. Consider the general expression for the cumulative phase term:

$${θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} . \qquad ( 19 )$$

In a generalized multi-dimensional CPM scheme, the basis vector is restricted to assume values over the real line. Hence, it can also contain irrational elements, which induces a time-varying phase state response. However, the problem of having a time-varying phase state space can be circumvented by defining qₘ(LT) in such a way that the product vₘqₘ(LT) is rational. Thus, one may potentially define qₘ(LT)= v̅ₘ, where v̅ₘ is chosen such that the product: v̅ₘ·vₘ=½, which is a rational number. (The ½ scaling enables one to make certain direct comparisons with conventional CPM).

As a simple yet illustrative example, let v₂=(1+\sqrt{5})/2. In this case, one may define v̅₂=−(1−\sqrt{5})/4 or v̅₂=1/(1+\sqrt{5}) to satisfy this constraint. Then,

$$\begin{matrix}{θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} \\ = {( 2 π h {\sum }_{i = 0}^{n - L} ( {λ}_{i , 1} \cdot 1 / 2 + {λ}_{i , 2} {q}_{2} ( LT ) {v}_{2} ) )}_{mod 2 π} \\ = {( 2 π h {\sum }_{i = 0}^{n - L} ( {λ}_{i , 1} \cdot 1 / 2 + {λ}_{i , 2} ( 1 + \sqrt{5} ) / 2 \cdot - ( 1 - \sqrt{5} ) / 4 ) )}_{mod 2 π} \\ = {( 2 π h {\sum }_{i = 0}^{n - L} ( {λ}_{i , 1} \cdot 1 / 2 + {λ}_{i , 2} ( 1 + \sqrt{5} ) / 2 \cdot - ( 1 - \sqrt{5} ) / 4 ) )}_{mod 2 π} \\ = {( π h {\sum }_{i = 0}^{n - L} ( {λ}_{i , 1} + {λ}_{i , 2} ) )}_{mod 2 π}\end{matrix} \qquad ( 20 )$$

Now, the cumulative phase can assume one of P values in each symbol interval (where h=K/P) and its state space has exactly the same characteristics as a conventional CPM waveform. Several illustrative examples are now presented.

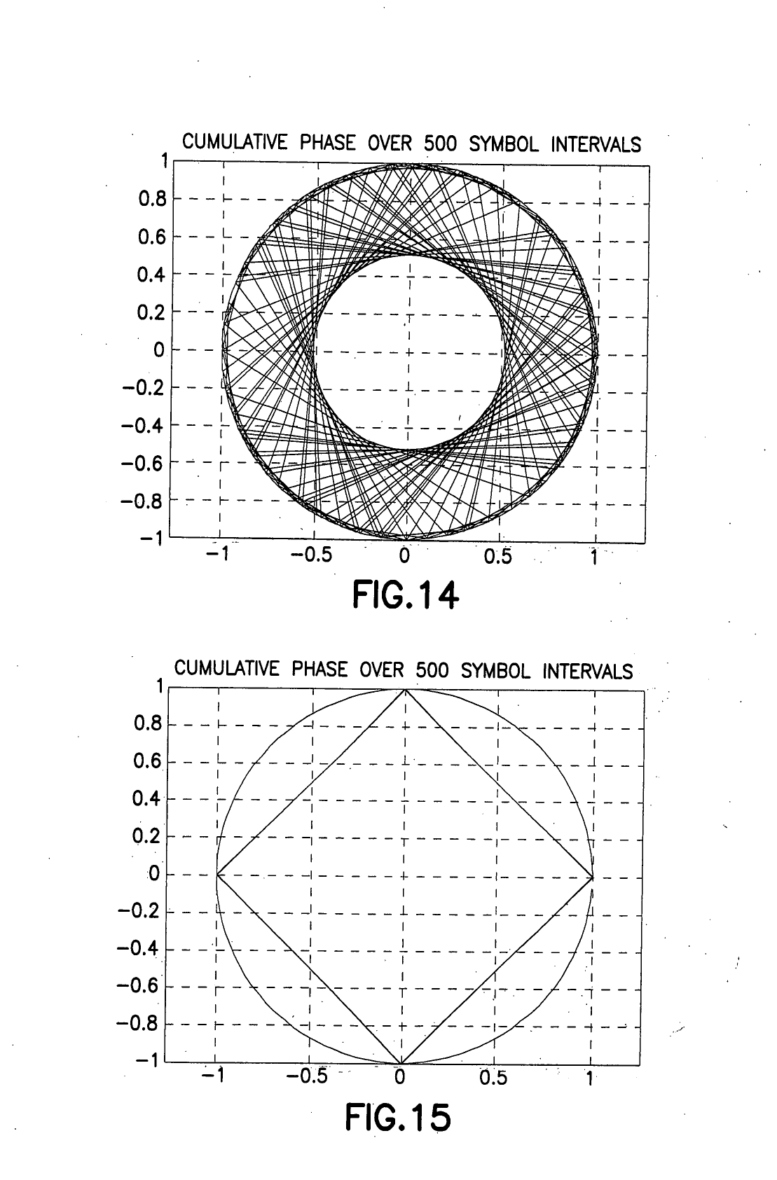

In FIG. 14 there is shown a progression of phase states for a multi-dimensional CPM waveform over 500 symbol intervals as joined points on the unit circle. For this waveform one may select v=└1(1+\sqrt{5})/2┘, h=¼, q₁(LT)=½, q₂(LT)=½. As the graph of FIG. 14 indicates, the number of cumulative phase states can be quite large over the 500 symbol window. However, in FIG. 15 the effect is shown of introducing the special phase response pulse shaping, and the use of signal parameters v=└1(1+\sqrt{5})/2┘, q₁(LT)=½,q₂(LT)=−(1−\sqrt{5}), h=¼. As can be seen, the resulting cumulative phase assumes only four values about the unit circle, which is exactly the same behavior as a conventional CPM waveform that uses h=¼.

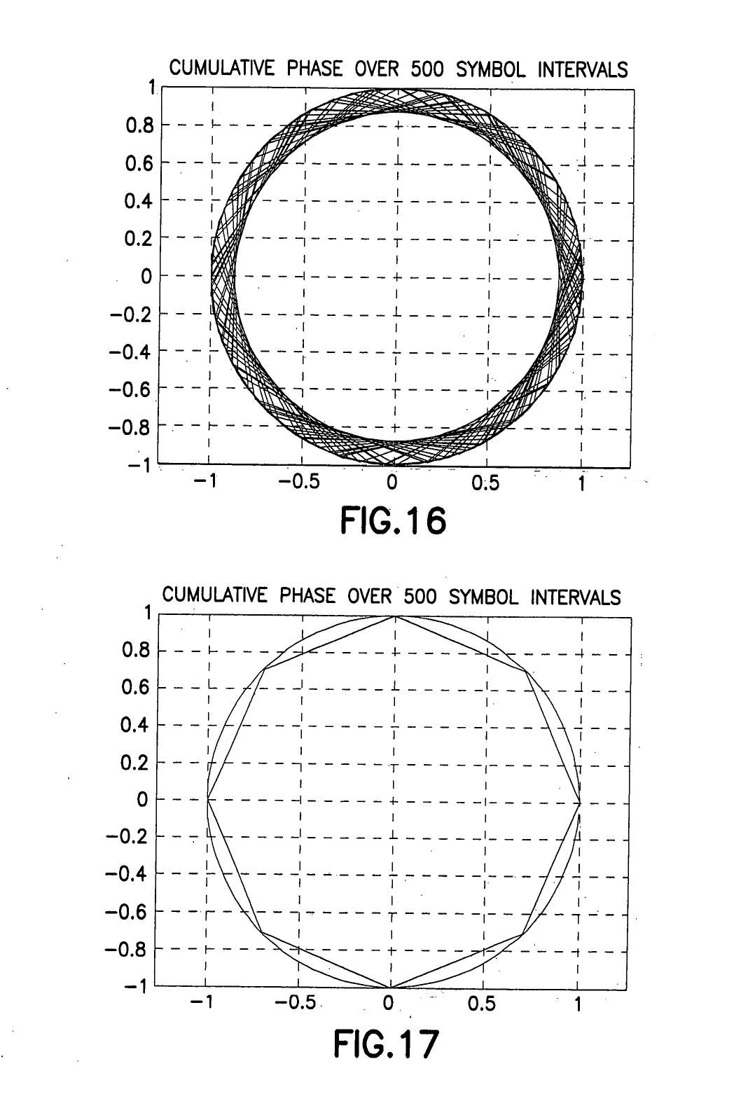

An additional example is shown in FIG. 16, where the signal parameters for the multi-dimensional CPM waveform are given by:

v=└1(1+\sqrt{5})/2┘,h=⅛,q₁(LT)=½,q₂(LT)=½.

As in the previous case, one may observe that the cumulative phase for multi-dimensional CPM can assume a large number of values as time evolves. However, FIG. 17 shows the impact of applying the phase response pulse shaping to this waveform. In FIG. 17 one may use v=└1(1+\sqrt{5})/2┘, q₁(LT)=½, q₂(LT)=−(1−\sqrt{5}),h=⅛. Now, the number of cumulative phase states is equal to eight, which is commensurate with conventional CPM using the same modulation index.

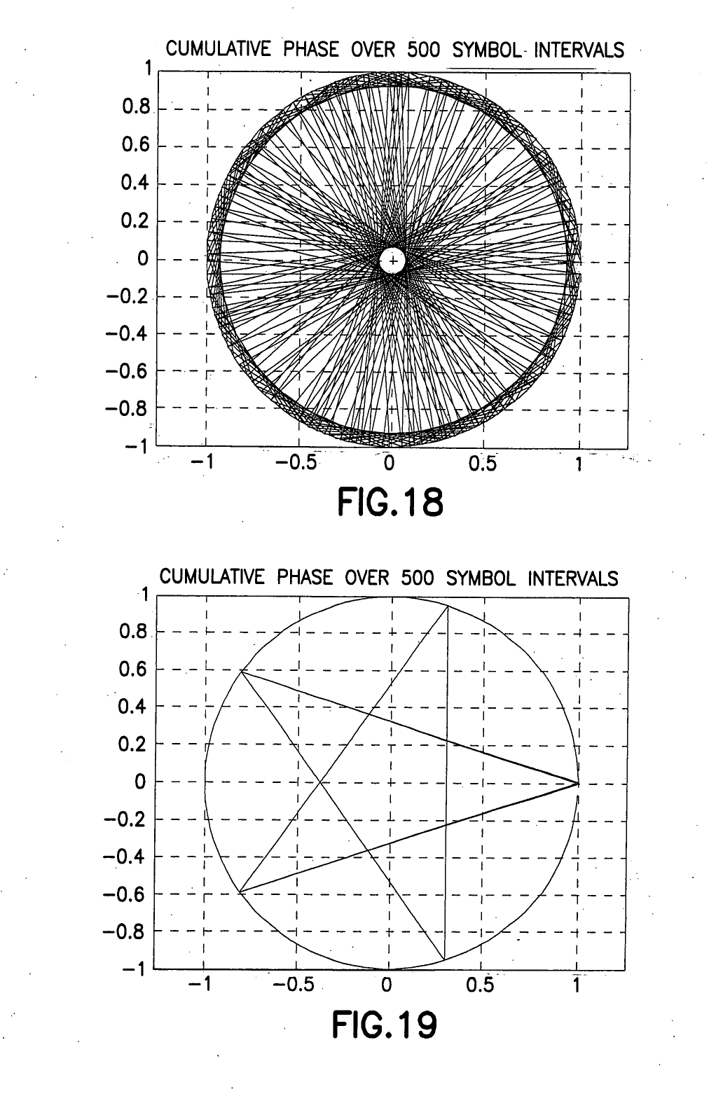

A further example is shown in FIG. 18, where the multi-dimensional CPM parameters are given by v=└1(1+\sqrt{5})/2┘,h=⅖, q₁(LT)=½, q₂(LT)=½. The number of phase states is large. However, after applying the phase response pulse shaping and using signal parameters v=└1(1+\sqrt{5})/2┘,h=⅖,q₁(LT)=½,q₂(LT)=−(1−\sqrt{5})/4, one finds that the number of phase states over 500 symbol intervals is equal to five, which is the same as that of a conventional CPM waveform that uses h=⅖ (see FIG. 19).

These three non-limiting examples serve to illustrate the utility of this embodiment of the invention, and the advantages that may be gained by applying it in order to reduce the state space complexity which, in turn, reduces the demodulation complexity.

Described now is an exemplary technique to determine a suitable smooth, continuous set of phase response functions that satisfy the two constraints

$${q}_{m} ( t ) = \{ \begin{matrix}0 & t \leq 0 \\ {\overline{v}}_{m} & t \geq LT\end{matrix} \\ m = 1 , … , M . \qquad ( 21 )$$

There are many possibilities for finding suitable sets of such functions. An intuitive approach which is useful from an illustrative point of view (although not necessarily optimal) is to define a smooth, piecewise continuous function for each signal dimension that is of the form

$$\begin{matrix}{q}_{m} ( t ) = \{ \begin{matrix}0 & t \leq 0 \\ q ( t ) & 0 \leq t < ( L - 1 ) T \\ {\overline{q}}_{m} ( t - ( L - 1 ) T ) & ( L - 1 ) T \leq t < LT\end{matrix} \\ where & ( 22 ) \\ q ( t ) = \{ \begin{matrix}0 & t \leq 0 \\ 1 / 2 & t = LT\end{matrix} \\ {\overline{q}}_{m} ( t ) = \{ \begin{matrix}1 / 2 & t = 0 \\ {\overline{v}}_{m} & t \geq T .\end{matrix} & ( 23 )\end{matrix}$$

Consider now an example for L=4 and a vector basis v=[1\sqrt{3}]. Since v₁=1, the phase pulse used on the first dimension can be conventionally defined. However, the phase pulse used on the second dimension may be defined as

$$\begin{matrix}q ( t ) = {\int }_{0}^{t} \frac{1}{2 ( L - 1 ) T} ( 1 - cos \frac{2 π v}{( L - 1 ) T} ) d v ; & 0 \leq t < ( L - 1 ) T \\ {\overline{q}}_{2} ( t ) = ( \frac{1}{2 {v}_{2}} - \frac{1}{2} ) {\int }_{0}^{t} \frac{1}{2 T} ( 1 - cos \frac{2 π v}{T} ) d v ; & 0 \leq t < T .\end{matrix} \qquad ( 24 )$$

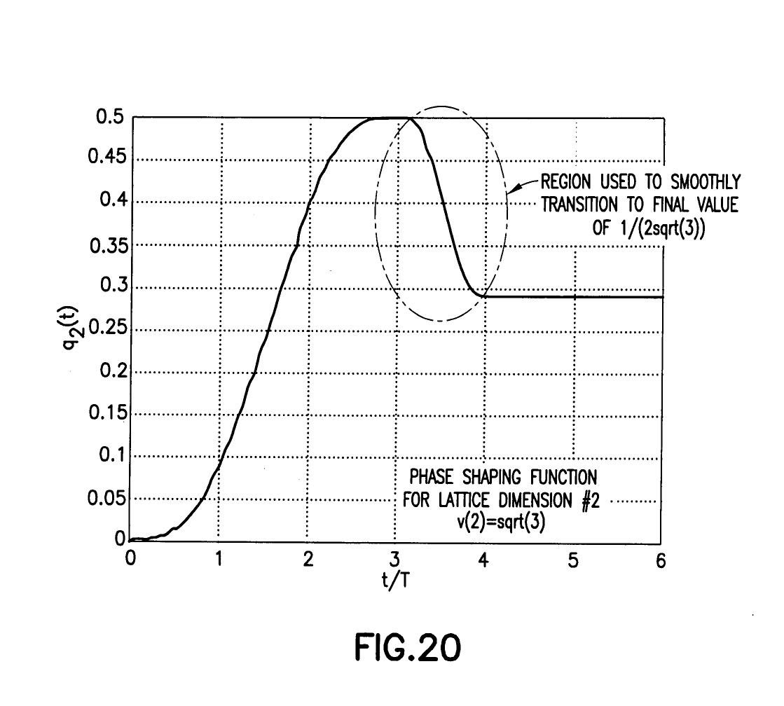

which is a raised cosine-type model. This waveform is illustrated in FIG. 20.

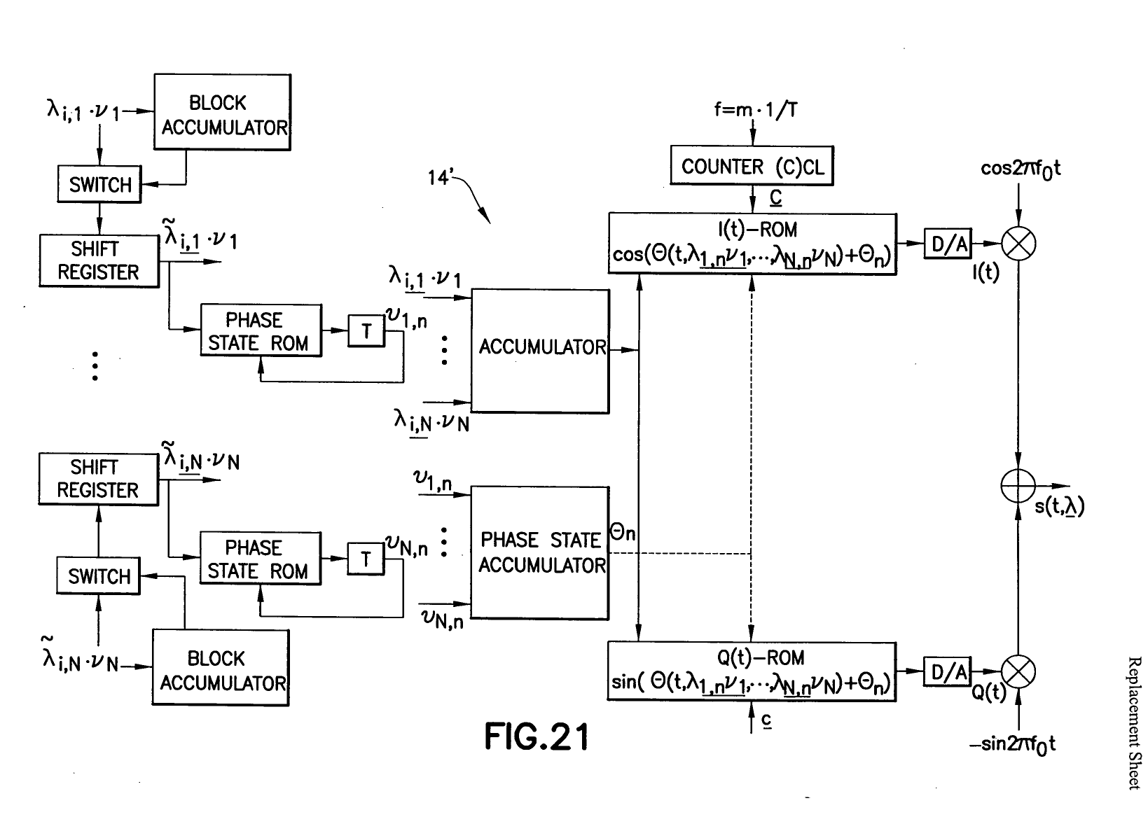

FIG. 21 is an exemplary circuit diagram, partially in block diagram form, that illustrates a generalized transmitter that includes the multi-dimensional CPM modulator 14′ that uses special data-dependent tail symbols, in accordance with an exemplary embodiment of this invention.

Note that the embodiment of the multi-dimensional CPM modulator 14 shown in FIG. 3 can be taken as also being descriptive of the embodiment of this invention that employs the use of pulse shaping of the phase response functions to force the phase state to be time-invariant.

The transmitted M-D CPM 19 waveform may be received by a base station (not shown) where it is demodulated to retrieve the information output from the information source 12. The information may be represented as data encoding an acoustic signal such as voice, or it may be data, such as user data and/or signaling data.

In other exemplary embodiments the M-D CPM modulator 14 may be embodied in a network node or component, such as a base station.

As should be realized, the use of exemplary embodiments of this invention enables a reduction to be made in the number of trellis states required for demodulation of the M-D CPM waveform from T=ΘₙM^{L-1}, where (Θₙ=2nP), to a constant value of T=PM^{L-1}. This represents a significant reduction in demodulation complexity at a low implementation cost at the transmitter device 10.

The use of an irrational information basis allows additional flexibility in transmission waveform design which is not available in conventional CPM. This additional flexibility may be used to optimize the spectral characteristics of the waveform so that it has better spectral containment than conventional CPM. Various optimization methods may be used to determine optimal phase response functions that can be used with the multi-dimensional CPM waveform.

When the M-D CPM transmission block is sufficiently long the use of the data-dependent tail symbol decreases the information rate, however only by an insignificant factor. Thus, it can be appreciated that at the cost of a slight decrease in performance a simple operation can be used to control the cumulative phase state space.

For example, a method comprises considering a complex baseband equivalent of a multi-dimensional CPM waveform defined as

s(t,λ)=e^{jφ(t,λ)},

where λ denotes a multi-dimensional information sequence, and assuming that transmissions begin at time t=0, then over an nth symbol interval an information carrying phase can be expressed as

$$φ ( t , λ ) = 2 π h {\sum }_{i = 0}^{n} {\sum }_{m = 1}^{\sqrt{M}} {λ}_{i , m} {v}_{m} {q}_{m} ( t - i T ) ,$$

where v={v₁, v₂, . . . , v_{\sqrt{M}}}ε [symbol] ^{\sqrt{M}} is an information-carrying basis vector and λ_{i,m} are the \sqrt{M}-ary information symbols that are carried on each signal dimension, where λ_{i,m}ε{±1,±3, . . . , ±(\sqrt{M}−1)}.

A \sqrt{M}-multi-dimensional CPM modulation may be employed as an alternative to M-ary CPM.

In the M-D CPM approach the phase response functions all satisfy the generalized constraints:

$${q}_{m} ( t ) = \{ \begin{matrix}0 , & t \leq 0 \\ {q}_{m} ( LT ) , & t \geq LT\end{matrix} \\ m = 1 , … , \sqrt{M} .$$

These constraints yield an equivalent representation of the phase function in terms of a partial response component and a generalized cumulative phase term, θₙ, and a, which are respectively given by

$$φ ( t , λ ) = {θ}_{n} + 2 π h {\sum }_{i = 0}^{L - 1} {\sum }_{m = 1}^{\sqrt{M}} {λ}_{i , m} {v}_{m} {q}_{m} ( τ + i T )$$

$${θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} ,$$

Over an nth symbol interval, multi-dimensional CPM is completely described by the set of phase response functions, {q₁(t), . . . , q\sqrt{M}^{(t)}}, the \sqrt{M} current input symbols, Λₙ└λ_{n,1} . . . λ_{n,\sqrt{M}}┘, a correlative state vector that describes the \sqrt{M}(L−1) past information symbols on each signal dimension σₙ=└λ_{n-(L-1),1} . . . λ_{n-(L-1)1,\sqrt{M}} . . . λ_{n-1,1} . . . λ_{n-1,\sqrt{M}}┘, and the cumulative phase term, θₙ.

In accordance with exemplary embodiments of this invention, in one aspect thereof a method comprises: defining a data-dependent tail symbol to reduce the phase state space of a M-D CPM waveform, where for a case that the (N−L)th input symbol in the transmission block can be represented as the cumulative sum of the N−L previous information symbols:

$${λ}_{N - L , m} = - {\sum }_{i = 0}^{N - L - 1} {λ}_{i , m} ,$$

the cumulative phase term at the beginning of the Nth symbol interval (which coincides with the start of the next transmission block) is

$$\begin{matrix}given by {θ}_{N} = [ π h {\sum }_{m = 1}^{\sqrt{M}} {\sum }_{i = 0}^{N - L} {λ}_{i , m} {v}_{m} ] mod 2 π \\ = [ π h {\sum }_{m = 1}^{\sqrt{M}} {\sum }_{i = 0}^{N - L - 1} {λ}_{i , m} {v}_{m} + π h {\sum }_{m = 1}^{\sqrt{M}} {λ}_{N - L , m} {v}_{m} ] mod 2 π \\ = 0.\end{matrix}$$

Further in accordance with exemplary embodiments of this invention, in another aspect thereof a method comprises: using phase response function shaping to reduce the phase state space of a M-D CPM waveform, where a general expression for the cumulative phase term may be presented as:

$${θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} .$$

The presence of a time-varying phase state space may be avoided by the method further comprising: defining qₘ(LT) in such a way that the product vₘqₘ(LT) is rational, and by thus defining qₘ(LT)= v̅ₘ, where v̅ₘ is chosen such that the product: v̅ₘ·vₘ=½, which is a rational number.

A computer program product in accordance with exemplary embodiments of this invention comprises computer-executable instructions stored in a computer-readable medium, the execution of which result in operations that comprise: defining a data-dependent tail symbol to reduce the phase state space of a M-D CPM waveform, where for a case that the (N−L)th input symbol in the transmission block can be represented as the cumulative sum of the N−L previous information symbols:

$${λ}_{N - L , m} = - {\sum }_{i = 0}^{N - L - 1} {λ}_{i , m} ,$$

the cumulative phase term at the beginning of the Nth symbol interval (which coincides with the start of the next transmission block) is given by

$$\begin{matrix}{θ}_{N} = [ π h {\sum }_{m = 1}^{\sqrt{M}} {\sum }_{i = 0}^{N - L} {λ}_{i , m} {v}_{m} ] mod 2 π \\ = [ π h {\sum }_{m = 1}^{\sqrt{M}} {\sum }_{i = 0}^{N - L - 1} {λ}_{i , m} {v}_{m} + π h {\sum }_{m = 1}^{\sqrt{M}} {λ}_{N - L , m} {v}_{m} ] mod 2 π \\ = 0.\end{matrix}$$

A computer program product in accordance with exemplary embodiments of this invention comprises computer-executable instructions stored in a computer-readable medium, the execution of which result in operations that comprise: using phase response function shaping to reduce the phase state space of a M-D CPM waveform, where a general expression for the cumulative phase term may be presented as:

$${θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} .$$

The presence of a time-varying phase state space may be avoided by operations that comprise: defining qₘ(LT) in such a way that the product vₘqₘ(LT) is rational, and by thus defining qₘ(LT)= v̅ₘ, where v̅ₘ is chosen such that the product: v̅ₘ·vₘ=½, which is a rational number.

A multi-dimensional CPM modulator in accordance with an exemplary embodiment of this invention comprises circuitry to generate a multi-dimensional CPM waveform and to define a data-dependent tail symbol to reduce the phase state space of the M-D CPM waveform, where for a case that the (N−L)th input symbol in the transmission block can be represented as the cumulative sum of the N−L previous information symbols:

$${λ}_{N - L , m} = - {\sum }_{i = 0}^{N - L - 1} {λ}_{i , m} ,$$

the cumulative phase term at the beginning of the Nth symbol interval (which coincides with the start of the next transmission block) is given by

$$\begin{matrix}{θ}_{N} = [ π h {\sum }_{m = 1}^{\sqrt{M}} {\sum }_{i = 0}^{N - L} {λ}_{i , m} {v}_{m} ] mod 2 π \\ = [ π h {\sum }_{m = 1}^{\sqrt{M}} {\sum }_{i = 0}^{N - L - 1} {λ}_{i , m} {v}_{m} + π h {\sum }_{m = 1}^{\sqrt{M}} {λ}_{N - L , m} {v}_{m} ] mod 2 π \\ = 0.\end{matrix}$$

Further in accordance with exemplary embodiments of this invention, a multi-dimensional CPM modulator comprises circuitry to generate a multi-dimensional CPM waveform and to use phase response function shaping to reduce the phase state space of the M-D CPM waveform, where a general expression for the cumulative phase term may be presented as:

$${θ}_{n} = {( 2 π h {\sum }_{i = 0}^{n - L} {\sum }_{m = 1}^{\sqrt{M}} {λ}_{i , m} {q}_{m} ( LT ) {v}_{m} )}_{mod 2 π} .$$

The presence of a time-varying phase state space may be avoided by the circuitry further defining qₘ(LT) in such a way that the product vₘqₘ(LT) is rational, and by thus defining qₘ(LT)= v̅ₘ, where v̅ₘ, is chosen such that the product: v̅ₘ·vₘ=½, which is a rational number.

The multi-dimensional CPM modulator as above, embodied in a mobile communication device.

The multi-dimensional CPM modulator as above, embodied as a part of a transmitter in a mobile communication device.

The multi-dimensional CPM modulator as above, embodied at least in part in an integrated circuit.

A description is now made of techniques to reduce the complexity that is required to transmit a coded multi-dimensional CPM signal using ring convolutional codes. As will be made apparent below, exemplary embodiments of this invention employ a non-trivial extension of Rimoldi's tilted phase research for conventional CPM (note that Rimoldi's results are not directly applicable to multi-dimensional CPM).

In its most general form, multi-dimensional CPM is characterized by a phase state space whose cardinality grows with time. This occurs due to the definition of the cumulative phase term, which may be expressed as:

$${θ}_{n} = ( 2 π h {\sum }_{i = 0}^{n - L} {\sum }_{m = 1}^{\sqrt{M}} {λ}_{i , m} {v}_{m} {q}_{m} ( LT ) ) mod 2 π . \qquad ( 25 )$$

As a non-limiting example, consider: \sqrt{M}=4, λ_{i,m}ε{−1,+1} for m=1,2 and v=└1\sqrt{3}┘. Then, the cumulative phase is given by

$${θ}_{n} = {( π h {\sum }_{i = 0}^{n - L} ( {λ}_{i , 1} + {λ}_{i , 2} \sqrt{3} ) )}_{mod 2 π} .$$

If one assumes that the phase state starts in the zero state: θ₀=0, the total number of possible cumulative phase states as a function of time are illustrated in FIG. 12, and clearly show how the cardinality of the phase state space description for multidimensional CPM increases with time. The size of the phase state space determines the complexity required to completely describe the multi-dimensional CPM waveform.

As described in detail below, the use of exemplary embodiments of this invention reduces the cardinality of the state space of multi-dimensional CPM by a factor of 2, which also reduces the required complexity of the optimal detector at the receiver of the multi-dimensional CPM waveform.

As described in detail below, exemplary embodiments of this invention provide a non-trivial extension of Rimoldi's tilted phase decomposition of conventional CPM signals, and further provide an alternate signal representation that reduces the trellis size (and hence decoding complexity) of multi-dimensional CPM waveforms. Exemplary embodiments of this invention can be used to generate coded multidimensional CPM using ring convolutional codes.

In the ensuing theoretical development it is shown that multi-dimensional CPM can be generated using a bank of continuous phase encoders (CPEs) followed by a memory-less modulator.

In the ensuing theoretical development it is further shown that the generalized tilted phase decomposition reduces the number of signal states that are required to describe the signal, and offers a key insight into encoding and decoding of the waveform.

A transmitter in accordance with exemplary embodiments of this invention may be used to simplify the design of concatenated coded schemes for use with multi-dimensional CPM. Concatenated multi-dimensional CPM is a new area for study, and represents a significant advance beyond the current state of the art, which has only considered concatenated convolutional encoding of conventional CPM.

As was noted above with regard to the discussion of Equations (7) and (10), consider a generalized multi-dimensional CPM waveform, whose information carrying phase function may be expressed as

$$φ ( t , λ ) = 2 π h {\sum }_{i = 0}^{n} {\sum }_{m = 1}^{\sqrt{M}} {λ}_{i , m} {v}_{m} {q}_{m} ( t - i T ) \\ t = n T + τ ; 0 \leq τ < T . \qquad ( 26 )$$

In (26) T denotes the symbol interval and h is the real-valued modulation index. This general formulation assigns smooth, continuous phase waveforms, qₘ(t), to each signaling dimension and defines a real information-carrying basis vector with elements v=└v₁ . . . v_{\sqrt{M}}┘. The information symbols, λ_{i,m}, are \sqrt{M}-ary, e.g. λ_{i,m}ε{±1,±3, ±\sqrt{M}−1} and the phase response functions all satisfy two generalized conditions

$${q}_{m} ( t ) = \{ \begin{matrix}0 & t \leq 0 \\ {q}_{m} ( LT ) & t \geq LT\end{matrix} \\ for m = 1 , … , \sqrt{M} . \qquad ( 27 )$$

The generalized description in (26) may suggest numerous signaling schemes, for which we there is presented a unified framework for the development of a generalized tilted phase decomposition method. This collective approach specifies the generalized structure of the continuous phase encoder, which can be used to more readily understand how it can be modified or combined with other encoders.

This derivation starts by a non-trivial generalization of Equation 8 from B. Rimoldi, “A decomposition approach to CPM”, EEEE Trans. On Information Theory, vol. 34, no. 2, March 1998, pp. 260-270, in order to obtain a commensurate expression for the so-called tilted phase, ψ(t,λ), for multi-dimensional CPM as a function of the physical phase, φ(t,λ)—

$$ψ ( t , λ ) = φ ( t , λ ) + \frac{2 π h ( \sqrt{M} - 1 ) \cdot t}{T} {\sum }_{m = 1}^{\sqrt{M}} {v}_{m} {q}_{m} ( LT ) . \qquad ( 28 )$$

The expression in (28) essentially uses the lowest phase trajectory in the physical phase as the new phase reference, which results in a ‘tilting’ of the axis. In Rimoldi's exposition, it is shown that this leads to a time-invariant phase trellis for any conventionally defined single-h CPM signal.

Now, after expanding (28) into its constituent terms one may see that the generalized tilted-phase can be written as the following sum of two data-dependent terms and one data-independent term:

$$ψ ( t , λ ) = 2 π h {\sum }_{m = 1}^{\sqrt{M}} {q}_{m} ( LT ) {v}_{m} {\sum }_{i = 0}^{L - 1} {λ}_{i , m} + 2 π h {\sum }_{m = 1}^{\sqrt{M}} {v}_{m} {\sum }_{i = n - L + 1}^{n} {λ}_{i , m} {q}_{m} ( t - i T ) + \frac{2 π h ( \sqrt{M} - 1 ) \cdot t}{T} {\sum }_{m = 1}^{\sqrt{M}} {v}_{m} {q}_{m} ( LT ) \qquad ( 29 )$$

Substituting t=nT+τ, where 0≦τ<T and n=0, 1, 2, . . . , yields

$$\begin{matrix}ψ ( t , λ ) = 2 π h {\sum }_{m = 1}^{\sqrt{M}} {v}_{m} {q}_{m} ( LT ) {\sum }_{i = 0}^{n - L} {λ}_{i , m} + 2 π h {\sum }_{m = 1}^{\sqrt{M}} {v}_{m} {\sum }_{i = 0}^{L - 1} {λ}_{n - i , m} {q}_{m} ( τ + i T ) + \frac{2 π h ( \sqrt{M} - 1 ) \cdot τ}{T} {\sum }_{m = 1}^{\sqrt{M}} {v}_{m} {q}_{m} ( LT ) + 2 π h ( \sqrt{M} - 1 ) \cdot n {\sum }_{m = 1}^{\sqrt{M}} {v}_{m} {q}_{m} ( LT ) . \\ Let & ( 30 ) \\ {U}_{i , m} = \frac{{λ}_{i , m} + ( \sqrt{M} - 1 )}{2} & ( 31 )\end{matrix}$$

be a modified data sequence that takes its values over the set {0, 1, . . . , \sqrt{M}−1}. Substituting (31) into (30), one obtains:

$$ψ ( τ + n T , U ) = ( 4 π h {\sum }_{m = 1}^{\sqrt{M}} {v}_{m} {q}_{m} ( LT ) {\sum }_{i = 0}^{n - L} {U}_{i , m} - 2 π h ( \sqrt{M} - 1 ) {\sum }_{m = 1}^{\sqrt{M}} {v}_{m} {q}_{m} ( LT ) {\sum }_{i = 0}^{n - L} 1 ) + ( \begin{matrix}4 π h {\sum }_{m = 1}^{\sqrt{M}} {v}_{m} {\sum }_{i = 0}^{L - 1} {U}_{n - i , m} {q}_{m} ( τ + i T ) - \\ 2 π h ( \sqrt{M} - 1 ) {\sum }_{m = 1}^{\sqrt{M}} {v}_{m} {\sum }_{i = 0}^{L - 1} {q}_{m} ( τ + i T )\end{matrix} ) + ( \begin{matrix}\frac{2 π h ( \sqrt{M} - 1 ) \cdot τ}{T} {\sum }_{m = 1}^{\sqrt{M}} {v}_{m} {q}_{m} ( LT ) + \\ 2 π h ( \sqrt{M} - 1 ) \cdot n {\sum }_{m = 1}^{\sqrt{M}} {v}_{m} {q}_{m} ( LT )\end{matrix} ) \qquad ( 32 )$$

which simplifies further to

$$ψ ( τ + n T , U ) = ( \begin{matrix}4 π h {\sum }_{m = 1}^{\sqrt{M}} {v}_{m} {q}_{m} ( LT ) {\sum }_{i = 0}^{n - L} {U}_{i , m} - \\ 2 π h ( \sqrt{M} - 1 ) ( n - L + 1 ) {\sum }_{m = 1}^{\sqrt{M}} {v}_{m} {q}_{m} ( LT )\end{matrix} ) + ( \begin{matrix}4 π h {\sum }_{m = 1}^{\sqrt{M}} {v}_{m} {\sum }_{i = 0}^{L - 1} {U}_{n - i , m} {q}_{m} ( τ + i T ) - \\ 2 π h ( \sqrt{M} - 1 ) {\sum }_{m = 1}^{\sqrt{M}} {v}_{m} {\sum }_{i = 0}^{L - 1} {q}_{m} ( τ + i T )\end{matrix} ) + ( \begin{matrix}\frac{2 π h ( \sqrt{M} - 1 ) τ}{T} {\sum }_{m = 1}^{\sqrt{M}} {v}_{m} {q}_{m} ( LT ) + \\ 2 π h ( \sqrt{M} - 1 ) \cdot n {\sum }_{m = 1}^{\sqrt{M}} {v}_{m} {q}_{m} ( LT )\end{matrix} ) . \qquad ( 33 )$$

After further straightforward manipulation one can obtain the final expression for the generalized tilted phase, which is given by

$$ψ ( τ + n T , U ) = ( \begin{matrix}4 π h {\sum }_{m = 1}^{\sqrt{M}} {q}_{m} ( LT ) {v}_{m} {\sum }_{i = 0}^{n - L} {U}_{i , m} + \\ 2 π h ( \sqrt{M} - 1 ) ( L - 1 ) {\sum }_{m = 1}^{\sqrt{M}} {q}_{m} ( LT ) {v}_{m}\end{matrix} ) + ( \begin{matrix}4 π h {\sum }_{m = 1}^{\sqrt{M}} {v}_{m} {\sum }_{i = 0}^{L - 1} {U}_{n - i , m} {q}_{m} ( τ + i T ) - \\ 2 π h ( \sqrt{M} - 1 ) {\sum }_{m = 1}^{\sqrt{M}} {v}_{m} {\sum }_{i = 0}^{L - 1} {q}_{m} ( τ + i T )\end{matrix} ) + ( \frac{2 π h ( \sqrt{M} - 1 ) τ}{T} {\sum }_{m = 1}^{\sqrt{M}} {v}_{m} {q}_{m} ( LT ) ) . \qquad ( 34 )$$

During each symbol interval, there is a data-independent contribution, which is dependent only on the translated time variable τ=t−nT. The data-independent contribution is given by

$$W ( τ ) = \frac{2 π h ( \sqrt{M} - 1 ) τ}{T} {\sum }_{m = 1}^{\sqrt{M}} {v}_{m} {q}_{m} ( LT ) - 2 π h ( \sqrt{M} - 1 ) {\sum }_{m = 1}^{\sqrt{M}} {v}_{m} {\sum }_{i = 0}^{L - 1} {q}_{m} ( τ + i T ) + 2 π h ( \sqrt{M} - 1 ) ( L - 1 ) {\sum }_{m = 1}^{\sqrt{M}} {v}_{m} {q}_{m} ( LT ) , 0 \leq τ < T \qquad ( 35 )$$

Taken modulo 2π, the generalized physical tilted phase term then becomes

$$\begin{matrix}\overline{ψ} ( τ + n T , U ) = {( ψ ( τ + n T , U ) + W ( τ ) )}_{mod 2 π} \\ = {( \begin{matrix}4 π h {\sum }_{m = 1}^{\sqrt{M}} {v}_{m} {q}_{m} ( LT ) {\sum }_{i = 0}^{n - L} {U}_{i , m} + \\ 4 π h {\sum }_{m = 1}^{\sqrt{M}} {v}_{m} {\sum }_{i = 0}^{L - 1} {U}_{n - i , m} {q}_{m} ( τ + i T ) + W ( τ )\end{matrix} )}_{mod 2 π} .\end{matrix} \qquad ( 38 )$$

With this signal representation, the generalized multi-dimensional CPM waveform is completely described by its correlative state vector of modified data symbols,

σₙ└U_{n-(L-1),1} . . . U_{n-1,1} . . . U_{n-(L-1),\sqrt{M}} . . . U_{n-1,\sqrt{M}}┘, (37)

its phase state

$${\overline{θ}}_{n} = [ 4 π h {\sum }_{m = 1}^{\sqrt{M}} {v}_{m} {q}_{m} ( LT ) {\sum }_{i = 0}^{n - L} {U}_{i , m} ] mod 2 π , \qquad ( 38 )$$

and the \sqrt{M} current (modified) input symbols

└U_{n,1} . . . U_{n,\sqrt{M}}┘. (39)

From this discussion it may become apparent that a multi-dimensional CPM modulator can be represented by a CPE followed by a MM, where the CPE determines the trellis structure of the CPM modulator. For rational h=K/P, where Q and P are relatively prime integers, the cumulative phase term can also be expressed as the following modulo P sum:

$${\overline{θ}}_{n} = {( 4 π h {\sum }_{i = 0}^{n - L} {( {\sum }_{m = 1}^{M} {v}_{m} {q}_{m} ( LT ) {U}_{i , m} )}_{mod P} )}_{mod 2 π} . \qquad ( 40 )$$

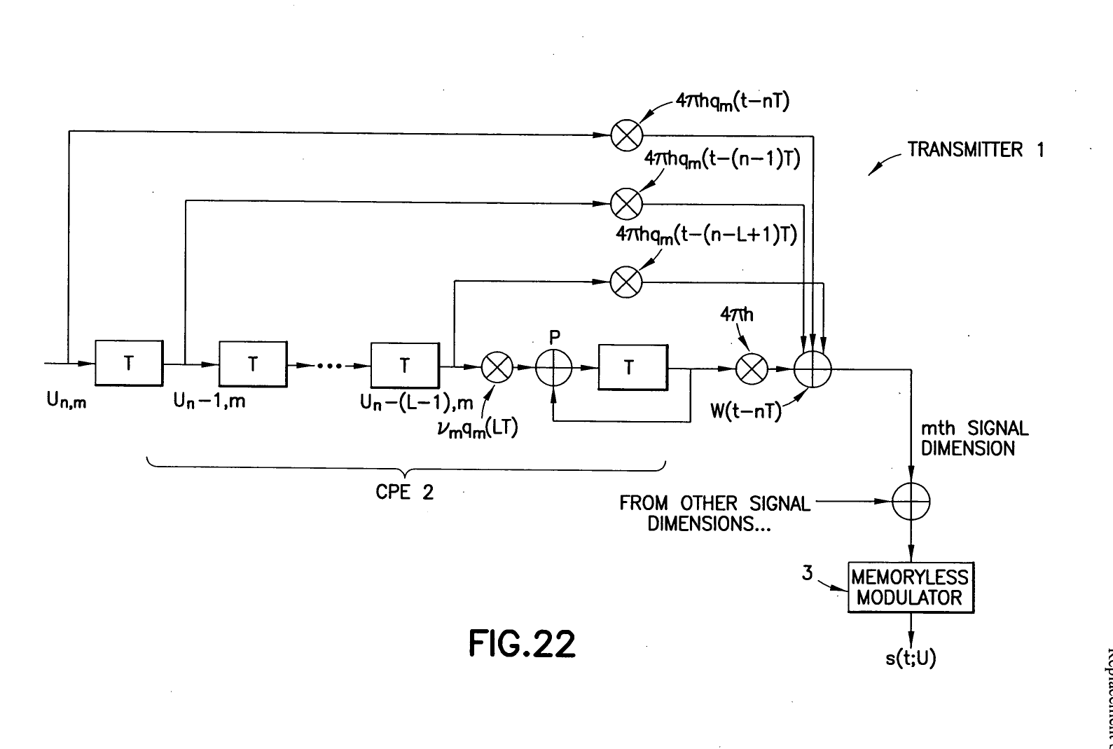

From (38) and the equivalent expression in (40) one may construct the generalized CPM tilted phase decomposition for multi-dimensional CPM. FIG. 22 shows a transmitter 1 architecture, which is comprised of the CPE 2 and the MM 3. Note that the CPE 2 is comprised of a linear encoder over the ring of integers modulo M (for h=1/M), and thus that the CPE 2 and channel encoder are over the same algebra.

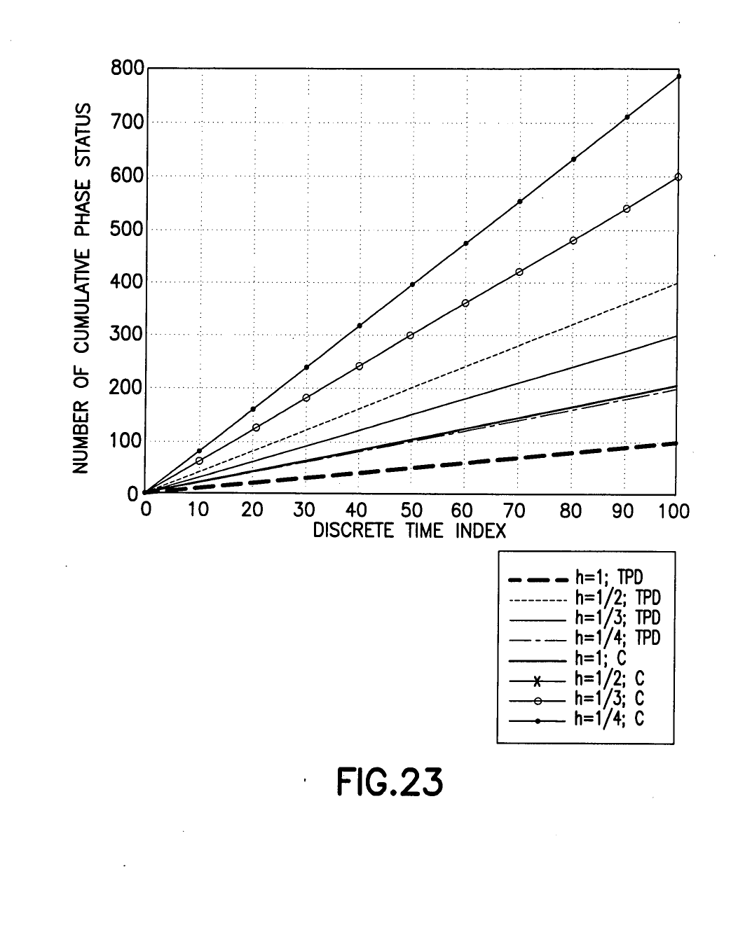

Finally, the generalized tilted phase decomposition reduces the size of the cumulative phase state space by a factor of 2, as is shown in FIG. 23, where a comparison is made of the number of cumulative phase states for a multi-dimensional CPM waveform under the generalized tilted phase decomposition versus the number of cumulative phase states using a conventional definition of the cumulative phase. The basis used for the multi-dimensional CPM signal is └1 \sqrt{3}┘. Thus, for the generalized phase decomposition, the following expression may be used for the cumulative phase to determine the number of possible phase states as a function of time:

$${\overline{θ}}_{n} = [ 4 π h {\sum }_{m = 1}^{\sqrt{M}} {v}_{m} {q}_{m} ( LT ) {\sum }_{i = 1}^{n - L} {U}_{i , m} ] mod 2 π , \qquad ( 41 )$$

and for a conventionally defined multi-dimensional CPM waveform, one may use the following expression:

$${θ}_{n} = ( 2 π h {\sum }_{i = 0}^{n - L} {\sum }_{m = 1}^{\sqrt{M}} {λ}_{i , m} {v}_{m} {q}_{m} ( LT ) ) mod 2 π . \qquad ( 42 )$$

As is shown in FIG. 23, the number of cumulative phase states with the generalized tilted phase representation is ½ that of the number of cumulative phase states under the conventional representation of multi-dimensional CPM. This offers the advantage of reduced complexity optimal detection.

It is noted that the references to “conventional” and “conventionally defined multi-dimensional CPM waveform” with regard to the description of FIG. 23 are not intended to indicate or imply that a multi-dimensional CPM waveform or method are known in the prior art, but should instead be construed as implying a non-tilted phase decomposition representation of the cumulative phase states of the multi-dimensional CPM waveform.

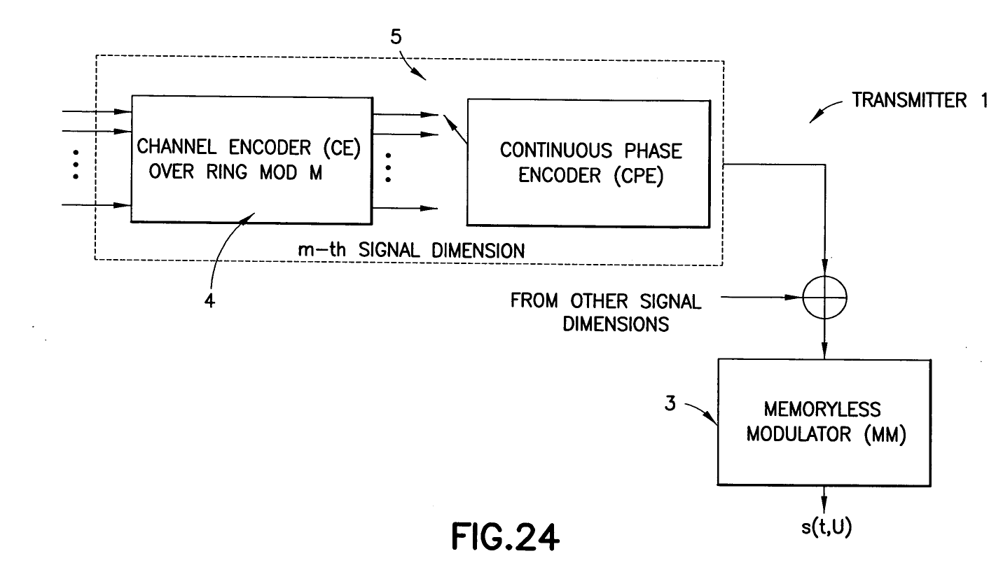

Finally, the generalized tilted phase decomposition facilitates coded multi-dimensional CPM over a ring of integers. One approach may be to employ a binary convolutional encoder followed by a binary-to-M-ary mapper as input to the multi-dimensional CPM signal. However, a mapper would be necessary to convert to M-ary symbols. Instead, it was shown above that the multi-dimensional CPM waveform can be decomposed into the CPE 2 followed by the MM 3, where the CPE 2 comprises is a linear encoder over the ring of integers modulo M (for h=1/M), and thus that the CPE 2 and the channel encoder 4 are over the same algebra. Therefore, no mapper is needed since the output of both are M-ary, and the output of the channel encoder 4 can be serialized (indicated logically by the switch 5) and fed into the CPE 2. This structure is shown in FIG. 24.

It should be noted that the generalized tilted phase decomposition for multi-dimensional CPM, as was discussed in detail above, yields a waveform that is identical to one that is generated by a conventional representation (e.g., a non-tilted phase decomposition representation) for multi-dimensional CPM.

The M-D CPM waveform 19 of FIG. 2 may be one that employs the generalized tilted phase decomposition in accordance with exemplary embodiments of this invention, and thus the M-D CPM modulator 14 may be constructed along the lines shown in FIG. 22 and/or FIG. 24. The use of the tilted phase decomposition in accordance with exemplary embodiments of this invention beneficially reduces the cardinality of the phase state space of the multi-dimensional CPM waveform by a factor of 2.

The transmitted M-D CPM waveform may be received by a base station (not shown) where it is demodulated to retrieve the information output from the information source 12. The information may be represented as data encoding an acoustic signal such as voice, or it may be data, such as user data and/or signaling data.

In accordance with exemplary embodiments of this invention a method defines a process, and a computer program product defines operations, to implement the generalized tilted phase decomposition so to reduce the cardinality of the phase state space of the multi-dimensional CPM waveform by a factor of 2, where during each symbol interval, taken modulo 2π, a generalized physical tilted phase term is given by:

$$\begin{matrix}\overline{ψ} ( τ + n T , U ) = {( ψ ( τ + n T , U ) + W ( τ ) )}_{mod 2 π} \\ = {( \begin{matrix}4 π h {\sum }_{m = 1}^{\sqrt{M}} {v}_{m} {q}_{m} ( LT ) {\sum }_{i = 0}^{n - L} {U}_{i , m} + \\ 4 π h {\sum }_{m = 1}^{\sqrt{M}} {v}_{m} {\sum }_{i = 0}^{L - 1} {U}_{n - i , m} {q}_{m} ( τ + i T ) + W ( τ )\end{matrix} )}_{mod 2 π} .\end{matrix}$$

Further in accordance with the method and the computer program product, a generalized multi-dimensional CPM waveform is completely described by its correlative state vector of modified data symbols, σₙ=└U_{n-(L-1),1} . . . U_{n-1,1} . . . U_{n-(L-1),\sqrt{M}} . . . U_{n-1,\sqrt{M}}┘, its phase state

$${\overline{θ}}_{n} = [ 4 π h {\sum }_{m = 1}^{\sqrt{M}} {v}_{m} {q}_{m} ( LT ) {\sum }_{i = 0}^{n - L} {U}_{i , m} ] mod 2 π ,$$

and the \sqrt{M} current (modified) input symbols └U_{n,1} . . . U_{n,\sqrt{M}}┘.

In accordance with a further aspect of exemplary embodiments of this invention a multi-dimensional CPM modulator is comprised of circuitry to implement tilted phase decomposition so to reduce the cardinality of the phase state space of the multi-dimensional CPM waveform by a factor of 2, where during each symbol interval, taken modulo 2π, a generalized physical tilted phase term is given by:

$$\begin{matrix}\overline{ψ} ( τ + n T , U ) = {( ψ ( τ + n T , U ) + W ( τ ) )}_{mod 2 π} \\ = {( \begin{matrix}4 π h {\sum }_{m = 1}^{\sqrt{M}} {v}_{m} {q}_{m} ( LT ) {\sum }_{i = 0}^{n - L} {U}_{i , m} + \\ 4 π h {\sum }_{m = 1}^{\sqrt{M}} {v}_{m} {\sum }_{i = 0}^{L - 1} {U}_{n - i , m} {q}_{m} ( τ + i T ) + W ( τ )\end{matrix} )}_{mod 2 π} .\end{matrix}$$

The multi-dimensional CPM modulator generates a multi-dimensional CPM waveform that is described by its correlative state vector of modified data symbols, σₙ=└U_{n-(L-1),1} . . . U_{n-1,1} . . . U_{n-(L-1),\sqrt{M}} . . . U_{n-1,\sqrt{M}}┘, its phase state

$${\overline{θ}}_{n} = [ 4 π h {\sum }_{m = 1}^{\sqrt{M}} {v}_{m} {q}_{m} ( LT ) {\sum }_{i = 0}^{n - L} {U}_{i , m} ] mod 2 π ,$$

and the \sqrt{M} current (modified) input symbols └U_{n,1} . . . U_{n,\sqrt{M}}┘.

The multi-dimensional CPM modulator as above, embodied in a mobile communication device.

The multi-dimensional CPM modulator as above, embodied as a part of a transmitter in a mobile communication device.

The multi-dimensional CPM modulator as above, embodied at least in part in an integrated circuit.

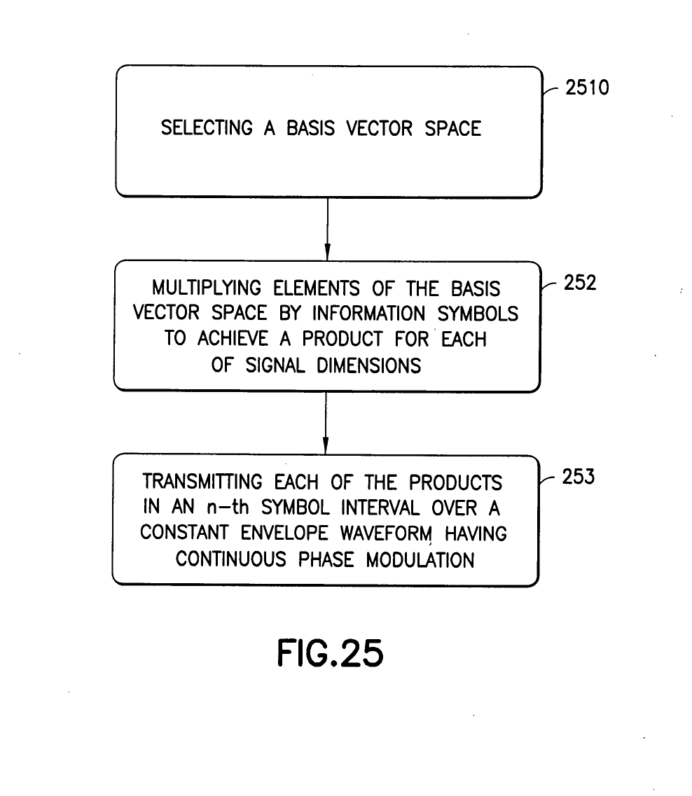

FIG. 25 shows a flow diagram of a method in accordance with an embodiment of this invention. In step 2510 a basis vector space v={v₁, . . . v_{\sqrt{M}}}ε [symbol] ^{\sqrt{M}} is selected. In step 2520 elements of the basis vector space v are multiplied by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions. At least one of the products is irrational. In step 2530 each of the products is transmitted in an n-th symbol interval over a constant envelope waveform having continuous phase modulation across the \sqrt{M} dimensions.

Based on the foregoing it should be apparent that exemplary embodiments of this invention provide a method, an apparatus and computer program product(s) to generate a M-D CPM waveform as a constant envelope, continuous phase signal capable of conveying a plurality of information symbols per symbol interval. The apparatus may be embodied in an integrated circuit.

Additionally, exemplary embodiments of this invention also provide a method, an apparatus and computer program product(s) to generate a M-D CPM waveform as a constant envelope, continuous phase signal capable of conveying a plurality of information symbols per symbol interval, and to reduce the phase state space of the M-D CPM waveform. Exemplary embodiments of this invention also provide an apparatus comprising means for generating a M-D CPM waveform as a constant envelope, continuous phase signal capable of conveying a plurality of information symbols per symbol interval; and means for reducing the phase state space of the M-D CPM waveform.

Furthermore, exemplary embodiments of this invention also provide a method and computer program product(s) to generate a M-D CPM waveform as a constant envelope, continuous phase signal capable of conveying a plurality of information symbols per symbol interval, and to reduce a number of trellis states required for demodulation of the M-D CPM waveform from T=ΘₙM^{L-1}, where (Θₙ=2nP), to a constant value of T=PM^{L-1}. Exemplary embodiments of this invention also provide a modulator comprising means for generating a M-D CPM waveform as a constant envelope, continuous phase signal capable of conveying a plurality of information symbols per symbol interval, and means for reducing a number of trellis states required for demodulation of the M-D CPM waveform from T=ΘₙM^{L-1}, where (Θₙ=2nP), to a constant value of T=PM^{L-1}.

Additionally, exemplary embodiments of this invention provide a method, apparatus and computer program product(s) to generate a M-D CPM waveform as a constant envelope, continuous phase signal capable of conveying a plurality of information symbols per symbol interval, and to implement generalized tilted phase decomposition to reduce the cardinality of the phase state space of the multi-dimensional CPM waveform by a factor of 2.

As such, it should be appreciated that at least some aspects of exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should be appreciated that exemplary embodiments of this invention may be employed in, as non-limiting examples, advanced third generation (3G) and fourth generation cellular communication systems and devices, as well as in other types of wireless communications systems and devices, such as one known as WiMAX (IEEE 802.16 and ETSI HiperMAN wireless MAN standards) as a non-limiting example.

As was noted, various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. The various blocks, apparatus, systems, techniques or methods described herein may be implemented in, as non-limiting examples, hardware, software, firmware, special purpose circuits or logic, general purpose hardware or controller or other computing devices, or some combination thereof.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
selecting a basis vector space v={v₁, . . . v_{\sqrt{M}}}ε [symbol] ^{\sqrt{M}};
multiplying elements of the basis vector space v by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions where at least one of the products is irrational;
transmitting each of the products in an n-th symbol interval over a constant envelope waveform having continuous phase modulation across the \sqrt{M} dimensions.

2. The method of claim 1, where the phase of the transmitted products is
$$φ ( t , λ ) = 2 π h {\sum }_{i = 0}^{n} {\sum }_{m = 1}^{\sqrt{M}} {λ}_{i , m} {v}_{m} {q}_{m} ( t - i T ) ;$$
qₘ is a phase response function; t is time; T is the symbol interval; and h is a modulation index.

3. The method of claim 1, where the waveform is transmitted over a mobile communication system.

4. The method of claim 2, where the phase state is time-invariant across the \sqrt{M} dimensions.

5. The method of claim 4, where the use of pulse shaping causes the phase state to be time-invariant.

6. The method of claim 4, where the transmitting comprises transmitting N consecutive symbols during which a cumulative phase is forced to zero at pre-specified intervals.

7. The method of claim 6, where the cumulative phase is forced to zero by tail bits appended to individual ones of the symbols.

8. The method of claim 4, where a number of trellis states is constant.

9. The method of claim 8, where the number of trellis states is PM^{L-1}; where L is the memory length of the transmitted waveform and P is a relatively prime integer.

10. The method of claim 1, where the multidimensional continuous phase modulation uses one of the following: a generalized tilted phase decomposition and ring convolution codes.

11. The method of claim 10, where the cumulative phase term used to determine the number of possible phase states is:
$${\overline{θ}}_{n} = [ 4 π h {\sum }_{m = 1}^{\sqrt{M}} {v}_{m} {q}_{m} ( LT ) {\sum }_{i = 0}^{n - L} {U}_{i , m} ] mod 2 π .$$

12. The method of claim 10, where the waveform is generated using a bank of continuous phase encoders and a memory-less modulator.

13. A device comprising:
a processor configured to select a basis vector space v={v₁, . . . v_{\sqrt{M}}}ε [symbol] ^{\sqrt{M}};
a processor configured to multiply elements of the basis vector space v by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions where at least one of the products is irrational;
a transmitter configured to transmit each of the products in an n-th symbol interval over a constant envelope waveform having continuous phase modulation across the \sqrt{M} dimensions.

14. The device of claim 13, where the phase of the transmitted products is
$$φ ( t , λ ) = 2 π h {\sum }_{i = 0}^{n} {\sum }_{m = 1}^{\sqrt{M}} {λ}_{i , m} {v}_{m} {q}_{m} ( t - i T ) ;$$
qₘ(t) is a phase response function; t is time; T is the symbol interval; and h is a modulation index.

15. The device of claim 13, where the waveform is transmitted over a mobile communication system.

16. The device of claim 14, where the phase state is time-invariant across the \sqrt{M} dimensions.

17. The device of claim 16, where the use of pulse shaping causes the phase state to be time-invariant.

18. The device of claim 16, where the transmitting comprises transmitting N consecutive symbols during which a cumulative phase is forced to zero at pre-specified intervals.

19. The device of claim 18, where the cumulative phase is forced to zero by tail bits appended to individual ones of the symbols.

20. The device of claim 18, where a number of trellis states is constant.

21. The device of claim 20, where the number of trellis states is PM^{L-1}; where L is the memory length of the transmitted waveform and P is a relatively prime integer.

22. The device of claim 13, where the multidimensional continuous phase modulation uses one of the following: a generalized tilted phase decomposition and ring convolution codes.

23. The device of claim 22, where the cumulative phase term used to determine the number of possible phase states is:
$${\overline{θ}}_{n} = [ 4 π h {\sum }_{m = 1}^{\sqrt{M}} {v}_{m} {q}_{m} ( LT ) {\sum }_{i = 0}^{n - L} {U}_{i , m} ] mod 2 π .$$

24. The device of claim 22, where the waveform is generated using a bank of continuous phase encoders and a memory-less modulator.

25. A computer readable medium embodied with a computer program, execution of which result in operations comprising:
selecting a basis vector space v={v₁, . . . v_{\sqrt{M}}}ε [symbol] ^{\sqrt{M}};
multiplying elements of the basis vector space v by information symbols λ_{i,m} of the set Λᵢ={λ_{i,1}, . . . λ_{i,\sqrt{M}}}ε [symbol] ^{\sqrt{M}} to achieve a product for each of \sqrt{M} signal dimensions where at least one of the products is irrational;
transmitting each of the products in an n-th symbol interval over a constant envelope waveform having continuous phase modulation across the \sqrt{M} dimensions.

26. The computer readable medium of claim 25, where the phase state is time-invariant across the \sqrt{M} dimensions.

27. The computer readable medium of claim 26, where the use of pulse shaping causes the phase state to be time-invariant.

28. The computer readable medium of claim 26, where the transmitting comprises transmitting N consecutive symbols during which a cumulative phase is forced to zero at pre-specified intervals.

29. The computer readable medium of claim 28, where the number of trellis states is constant.

30. The computer readable medium of claim 25, where the multidimensional continuous phase modulation uses one of the following: a generalized tilted phase decomposition and ring convolution codes.

31. The computer readable medium of claim 30, where the cumulative phase term used to determine the number of possible phase states is:
$${\overline{θ}}_{n} = [ 4 π h {\sum }_{m = 1}^{\sqrt{M}} {v}_{m} {q}_{m} ( LT ) {\sum }_{i = 0}^{n - L} {U}_{i , m} ] mod 2 π .$$

32. An apparatus comprising:
means for selecting a basis vector space v={v₁, . . . v_{\sqrt{M}}}ε [symbol] ^{\sqrt{M}};
means for multiplying elements of the basis vector space v by information symbols λ_{i,m} of the set Λᵢ={λ_{i,1}, . . . λ_{i,\sqrt{M}}}ε [symbol] ^{\sqrt{M}} to achieve a product for each of V signal dimensions where at least one of the products is irrational;
means for transmitting each of the products in an n-th symbol interval over a constant envelope waveform having continuous phase modulation across the \sqrt{M} dimensions.

33. The apparatus of claim 32, where the phase state is time-invariant across the \sqrt{M} dimensions.

34. The apparatus of claim 33, where the transmitting comprises transmitting N consecutive symbols during which a cumulative phase is forced to zero at pre-specified intervals by tail bits appended to individual ones of the symbols.

35. The device of claim 32, where the multidimensional continuous phase modulation uses one of the following: a generalized tilted phase decomposition and ring convolution codes.

36. The device of claim 32, where the means for selecting and the means for multiplying comprise a processor; and
the means for transmitting comprises a transmitter.
